(19) United States
(12) Patent Application Publication
(10) Pub. No.: US 2021/0329933 A1
(43) Pub. Date: Oct. 28, 2021

(54) METHOD FOR INCREASING SHELF LIFE OF FRUIT

(71) Applicant: Westfalia Fruit International Limited, Kent (GB)

(72) Inventor: Graham Alexander Young, Kent (GB)

(21) Appl. No.: 17/312,851

(22) PCT Filed: Dec. 11, 2019
(86) PCT No.: PCT/GB2019/053499

§ 371 Date: Jun. 10, 2021

(30) Foreign Application Priority Data
Dec. 13, 2018 (GB) 1820290.3

(51) Int. Cl. A23B 7/152; A23B 7/015; A23B 7/04; A23L 19/00; A23L 3/28; B65B 25/04; B65B 31/00; B65D 81/20; B65D 85/34

(52) U.S. Cl. CPC A23B 7/152; A23B 7/015; A23B 7/04; A23L 19/03; A23V 2002/00; B65B 25/041; B65B 31/00; B65D 81/2084; B65D 85/34; A23L 3/28

(57) ABSTRACT

The present invention relates to a method for increasing the shelf life of fruit comprising the steps of: treating a fruit with UV light from a UV light source, packaging the fruit in packaging film that allows the fruit to be stored in a modified atmosphere within the packaging film, and storing the packaged fruit, wherein the fruit has a high dry-matter content.

### FIELD

The present invention relates to a method for extending the shelf life of fruit which has a high dry-matter content. In particular, it relates to a method for extending the shelf life of avocados, which may be ripen-at-home avocados (RAH), that are stored at a chilled or ambient temperature.

### BACKGROUND

The avocado (Persea americana) belongs to the family Lauraceae (which also include the bay laurel) and is one of the major fruit crops in the world. It is native to Central America but is grown in tropical and sub-tropical regions of the world. The demand for this fruit is high as a result of (i) increased consumer awareness of the fruit's dietary value and uses (ii) improved fruit quality resulting from the implementation of maturity standards and important storage and transportation facilities (Naiman & Hyman, 2007: Acta Horticulture 761: 397-402). The fruit has a markedly higher fat content than most other fruits, mostly monounsaturated fat. It is used as the base for the Mexican dip known as guacamole and also used in the preparation of chocolate syrup, ice-cream, milk-shakes and other dessert drinks (Whiley et al., 2002: The Avocado. UK: CABI publisher: 366-388).

High levels of dry-matter in fruits, such as avocados, can shorten the shelf-life of the fruit. The avocado is an unusual fruit in that it can be held on the tree for very long periods after reaching physiological maturity (defined as the ability to ripen after harvest). In some environments, fruit can be held on the tree for one year or more after physiological maturity. Late maturing avocado cultivars are often “stored” on the tree, especially in cool climates, to supply high-priced markets when fruit availability is low. These fruit are often more prone to disease, rancidity and faster post-storage ripening. The more mature a fruit is (as determined by the percentage dry-matter and the harvest date) the greater the tendency to ripen more quickly (The Avocado Botany, Production and Uses 2^{nd} Edition. Edited by Bruce Schaffer, B. Nigel Wolstenholme and Anthony W. Whiley pages 494, 496 and 499). Fruit retailers find that a shortened shelf-life for fruit has the potential for a large amount of wastage especially during periods of low sales. As well as causing environmental issues due to the subsequent disposal of rotten fruit, this is also costly in monetary terms for the retailer.

UV radiation, in particular UV-C radiation, is a technology used in food processing to improve the safety and extend the shelf life of food products by inactivating pathogenic and spoilage-related microorganisms on food surfaces (Guerrero-Beltran & Barbosa-Cánovas (2004) Food Science and Technology International, 10, 137-147). The wavelength range found to obtain a germicidal effect is often quoted as around 220-300 nm. The germicidal effect is attributed to injuries in the DNA of microorganisms caused by the absorption of the UV-C radiation leading to disruption of cell growth (Koutchma, Forney, & Moraru (2009) In T. Koutchma, L. Forney, & C. Moraru (Eds.), Ultraviolet light in food technology (pp. 1-32) Boca Raton, Fla.; CRC Press). However, UV-C irradiation is generally not sufficient on its own to significantly increase the shelf-life of fruit.

Conventional devices, such as refrigeration and Modified Atmosphere Packaging (MAP), have been used to extend the shelf life of fruits, vegetables, floral and other perishable products. Examples of such conventional devices related to MAP are disclosed in U.S. Pat. Nos. 6,880,748 and 7,597,240. The basic idea of the MAP technique relating to fresh fruits and vegetables is the replacement or modification of the air of packaging headspace with predetermined atmospheric gases different in proportion from that of air. Modified atmosphere conditions are typically exemplified by low O₂ and high CO₂ concentrations relative to that of air. This is known to slow down respiration and ripening of packaged fruits. While these systems are also known for use with avocados, it is traditionally used in combination with, for example, refrigeration in order to allow for further retardation of ripening and long-term storage. (Meir et al. (1997) Postharvest Biology and Technology 12, 51-60). However, the use of refrigeration is costly due to the high energy demand, and it can cause further environmental issues.

A need continues to exist for effective and reliable packaging for fruit, such as avocados, which reduces the amount of wastage.

The methods according to this application produce a packaging which improves the shelf life of fruit, such as avocados, which have high levels of dry-matter (such as avocados produced later in the season and mature avocados).

### SUMMARY

The present inventors have discovered that fruit, such as avocados, which have a high level of dry-matter have different MAP packaging requirements compared to fruits with lower levels of dry-matter.

The present inventors have discovered that the combined use of UV irradiation and MAP packaging film with a specific OTR has a synergistic effect on the shelf-life of fruits with high levels of dry-matter, such as avocado. In particular, the methods and apparatus of the present invention are useful in increasing the shelf-life of ripen-at-home fruits, especially those stored at a chilled temperature.

Briefly, this specification generally discloses methods for increasing the shelf life of fruit, such as avocados, by treating the fruit with UV light and packaging the fruit in a MAP film, as well as packaged fruit prepared by the process and a fruit packaging apparatus.

Further benefits of the teachings of this specification will be apparent to one skilled in the art from reading this specification.

### BRIEF DESCRIPTION OF THE DRAWINGS

FIG. 1 shows an embodiment of the apparatus of the present invention.

FIG. 2 shows an embodiment of applying the process of the present invention.

FIG. 3 depicts the use of a penetrometer.

FIG. 4A shows the mean percentage of moisture lost during the trial from RAH avocados stored at a chilled temperature and packaged in a MAP film with an OTR of 14300 cc/m²/day. FIG. 4B shows the mean levels of O₂ and CO₂ in the headspace throughout the trial of RAH avocados stored at a chilled temperature and packaged in a MAP film with an OTR of 14300 cc/m²/day. FIG. 4C shows the mean firmness of RAH avocados stored at a chilled temperature; the left-hand column for each day after packaging represents the needle-perforated film and the right-hand column for each day after packaging represents the MAP film with an OTR of 14,300 cc/m²/day. P+ denotes the number of days after packaging.

FIG. 5 shows RAH avocados stored at a chilled temperature in needle-perforated film.

FIG. 6 shows RAH avocados stored at a chilled temperature in MAP film with an OTR of 14,300 cc/m²/day.

FIG. 7A shows the mean percentage of moisture lost during the trial from RAH avocados stored at an ambient temperature and packaged in a MAP film with an OTR of 14300 cc/m²/day. FIG. 7B shows the mean levels of O₂ and CO₂ in the headspace throughout the trial of RAH avocados stored at an ambient temperature packaged in a MAP film with an OTR of 14300 cc/m²/day. FIG. 7C shows the mean firmness of RAH avocados stored at ambient temperature; the left-hand column for each day after packaging represents the needle-perforated film and the right-hand column for each day after packaging represents the MAP film with an OTR of 14,300 cc/m²/day.

FIG. 8 shows RAH avocados stored at an ambient temperature in needle-perforated film.

FIG. 9 shows RAH avocados stored at an ambient temperature in MAP film with an OTR of 14,300 cc/m²/day.

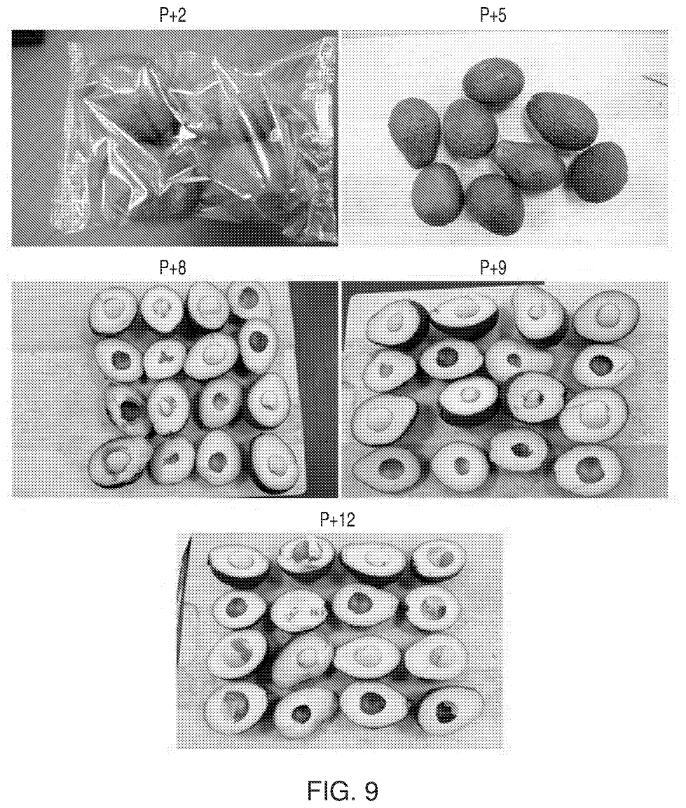

FIG. 10 shows the dry-matter content of Hass avocados grown in South Africa throughout the season.

### DETAILED DESCRIPTION

This detailed description is intended to acquaint others skilled in the art with Applicant's invention, its principles, and its practical application so that others skilled in the art may adapt and apply Applicant's invention in its numerous forms, as they may be best suited to the requirements of a particular use. This detailed description and its specific examples, while indicating certain embodiments, are intended for purposes of illustration only. This specification, therefore, is not limited to the described embodiments, and may be variously modified.

In a broad aspect, the present invention provides a method for increasing the shelf life of fruit comprising the steps of:

i) treating a fruit with UV light from a UV light source,

ii) packaging the fruit in packaging film that allows the fruit to be stored in a modified atmosphere within the packaging film, and

iii) storing the packaged fruit,

wherein the packaging film is a modified atmosphere packaging (MAP) film, wherein the MAP film has an oxygen transmission rate (OTR) of about 8000 cc/m²/day to about 45000 cc/m²/day; and

wherein the method is capable of increasing the shelf life of the packaged fruit by at least 1 day or 2 days when the packaged fruit is stored at a chilled temperature;

and/or

wherein the method is capable of increasing the shelf life of the packaged fruit by at least 1 day or 2 days when the packaged fruit is stored at an ambient temperature;

and/or

wherein the method is capable of increasing the shelf life of the packaged fruit by at least 1 day or 2 days when the packaged fruit is first stored at a chilled temperature followed by storage at an ambient temperature.

In a broad aspect, the present invention provides a method for increasing the shelf life of fruit comprising the steps of:

i) treating a fruit with UV light from a UV light source,

ii) packaging the fruit in packaging film that allows the fruit to be stored in a modified atmosphere within the packaging film, and

iii) storing the packaged fruit,

wherein the fruit has a high dry-matter content;

wherein the packaging film is a modified atmosphere packaging (MAP) film, wherein the MAP film has an oxygen transmission rate (OTR) of about 8000 cc/m²/day to about 45000 cc/m²/day; and

wherein the method is capable of increasing the shelf life of the packaged fruit by at least 1 day or 2 days when the packaged fruit is stored at a chilled temperature;

and/or

wherein the method is capable of increasing the shelf life of the packaged fruit by at least 1 day or 2 days when the packaged fruit is stored at an ambient temperature;

and/or

wherein the method is capable of increasing the shelf life of the packaged fruit by at least 1 day or 2 days when the packaged fruit is first stored at a chilled temperature followed by storage at an ambient temperature.

The present invention provides a method for increasing the shelf life of fruit comprising the steps of:

i) treating a fruit with UV light from a UV light source,

ii) packaging the fruit in packaging film that allows the fruit to be stored in a modified atmosphere within the packaging film, and

iii) storing the packaged fruit,

wherein the fruit has a high dry-matter content;

wherein the packaging film is a modified atmosphere packaging (MAP) film, wherein the MAP film has an oxygen transmission rate (OTR) of about 8000 cc/m²/day to about 19500 cc/m²/day; and

wherein the method is capable of increasing the shelf life of the packaged fruit by at least 1 day or 2 days when the packaged fruit is stored at a chilled temperature;

and/or

wherein the method is capable of increasing the shelf life of the packaged fruit by at least 1 day or 2 days when the packaged fruit is stored at an ambient temperature;

and/or

wherein the method is capable of increasing the shelf life of the packaged fruit by at least 1 day or 2 days when the packaged fruit is first stored at a chilled temperature followed by storage at an ambient temperature.

The present invention provides a method for increasing the shelf life of fruit comprising the steps of:

i) treating a fruit with UV light from a UV light source,

ii) packaging the fruit in packaging film that allows the fruit to be stored in a modified atmosphere within the packaging film, and

iii) storing the packaged fruit,

wherein the fruit has a high dry-matter content;

wherein the packaging film is a modified atmosphere packaging (MAP) film, wherein the MAP film has an oxygen transmission rate (OTR) of about 8000 cc/m²/day to about 17500 cc/m²/day; and

wherein the method is capable of increasing the shelf life of the packaged fruit by at least 1 day or 2 days when the packaged fruit is stored at a chilled temperature;

and/or

wherein the method is capable of increasing the shelf life of the packaged fruit by at least 1 day or 2 days when the packaged fruit is stored at an ambient temperature;

and/or

wherein the method is capable of increasing the shelf life of the packaged fruit by at least 1 day or 2 days when the packaged fruit is first stored at a chilled temperature followed by storage at an ambient temperature.

In a further aspect, the present invention provides a packaged fruit prepared by the method according to the present invention.

In another broad aspect, the present invention provides a fruit packaging apparatus having

a) a UV light source;

b) a fruit packer capable of packaging a fruit in a packaging film that allows the fruit to be stored in a modified atmosphere within the packaging film;

c) a surface for holding the fruit wherein the surface is movable between the UV light source and the fruit packer so that the fruit can be exposed to the UV light source and fruit packer sequentially;

wherein the packaging film is a MAP film, wherein the MAP film has an oxygen transmission rate (OTR) of about 8000 cc/m²/day to about 45000 cc/m²/day; and

wherein the packaged fruit has an increase in shelf life of at least 1 day or 2 days when the packaged fruit is stored at a chilled temperature;

and/or

wherein the packaged fruit has an increase in shelf life of at least 1 day or 2 days when it is stored at an ambient temperature;

and/or

wherein the method is capable of increasing the shelf life of the packaged fruit by at least 1 day or 2 days when the packaged fruit is first stored at a chilled temperature followed by storage at an ambient temperature.

In another broad aspect, the present invention provides a fruit packaging apparatus having

a) a UV light source;

b) a fruit packer capable of packaging a fruit in a packaging film that allows the fruit to be stored in a modified atmosphere within the packaging film;

c) a surface for holding the fruit wherein the surface is movable between the UV light source and the fruit packer so that the fruit can be exposed to the UV light source and fruit packer sequentially;

wherein the packaging film is a MAP film, wherein the MAP film has an oxygen transmission rate (OTR) of about 8000 cc/m²/day to about 25000 cc/m²/day; and

wherein the packaged fruit has an increase in shelf life of at least 1 day or 2 days when the packaged fruit is stored at a chilled temperature;

and/or

wherein the packaged fruit has an increase in shelf life of at least 1 day or 2 days when it is stored at an ambient temperature;

and/or

wherein the method is capable of increasing the shelf life of the packaged fruit by at least 1 day or 2 days when the packaged fruit is first stored at a chilled temperature followed by storage at an ambient temperature.

In another aspect, the present invention provides a fruit packaging apparatus having

a) a UV light source;

b) a fruit packer capable of packaging a fruit in a packaging film that allows the fruit to be stored in a modified atmosphere within the packaging film;

c) a surface for holding the fruit wherein the surface is movable between the UV light source and the fruit packer so that the fruit can be exposed to the UV light source and fruit packer sequentially;

wherein the packaging film is a MAP film, wherein the MAP film has an oxygen transmission rate (OTR) of about 8000 cc/m²/day to about 19500 cc/m²/day;

and

wherein the packaged fruit has an increase in shelf life of at least 1 day or 2 days when the packaged fruit is stored at a chilled temperature;

and/or

wherein the packaged fruit has an increase in shelf life of at least 1 day or 2 days when it is stored at an ambient temperature;

and/or

wherein the method is capable of increasing the shelf life of the packaged fruit by at least 1 day or 2 days when the packaged fruit is first stored at a chilled temperature followed by storage at an ambient temperature.

In another aspect, the present invention provides a fruit packaging apparatus having

a) a UV light source;

b) a fruit packer capable of packaging a fruit in a packaging film that allows the fruit to be stored in a modified atmosphere within the packaging film;

c) a surface for holding the fruit wherein the surface is movable between the UV light source and the fruit packer so that the fruit can be exposed to the UV light source and fruit packer sequentially;

wherein the packaging film is a MAP film, wherein the MAP film has an oxygen transmission rate (OTR) of about 8000 cc/m²/day to about 17500 cc/m²/day;

and

wherein the packaged fruit has an increase in shelf life of at least 1 day or 2 days when the packaged fruit is stored at a chilled temperature;

and/or

wherein the packaged fruit has an increase in shelf life of at least 1 day or 2 days when it is stored at an ambient temperature;

and/or

wherein the method is capable of increasing the shelf life of the packaged fruit by at least 1 day or 2 days when the packaged fruit is first stored at a chilled temperature followed by storage at an ambient temperature.

In another broad aspect, the present invention provides a fruit packaging apparatus having

a) a UV light source;

b) a fruit packer comprising a packaging film wherein said fruit packer is configured to package a fruit in the packaging film that allows the fruit to be stored in a modified atmosphere within the packaging film;

c) a surface for holding the fruit wherein the surface is movable between the UV light source and the fruit packer so that the fruit can be exposed to the UV light source and fruit packer sequentially;

wherein the packaging film is a MAP film, wherein the MAP film has an oxygen transmission rate (OTR) of about 8000 cc/m²/day to about 45000 cc/m²/day.

In another broad aspect, the present invention provides a fruit packaging apparatus having

a) a UV light source;

b) a fruit packer comprising a packaging film wherein said fruit packer is configured to package a fruit in the packaging film that allows the fruit to be stored in a modified atmosphere within the packaging film;

c) a surface for holding the fruit wherein the surface is movable between the UV light source and the fruit packer so that the fruit can be exposed to the UV light source and fruit packer sequentially;

wherein the packaging film is a MAP film, wherein the MAP film has an oxygen transmission rate (OTR) of about 8000 cc/m²/day to about 25000 cc/m²/day.

In another aspect, the present invention provides a fruit packaging apparatus having

a) a UV light source;

b) a fruit packer comprising a packaging film wherein said fruit packer is configured to package a fruit in the packaging film that allows the fruit to be stored in a modified atmosphere within the packaging film;

c) a surface for holding the fruit wherein the surface is movable between the UV light source and the fruit packer so that the fruit can be exposed to the UV light source and fruit packer sequentially;

wherein the packaging film is a MAP film, wherein the MAP film has an oxygen transmission rate (OTR) of about 8000 cc/m²/day to about 19500 cc/m²/day.

In another aspect, the present invention provides a fruit packaging apparatus having

a) a UV light source;

b) a fruit packer comprising a packaging film wherein said fruit packer is configured to package a fruit in the packaging film that allows the fruit to be stored in a modified atmosphere within the packaging film;

c) a surface for holding the fruit wherein the surface is movable between the UV light source and the fruit packer so that the fruit can be exposed to the UV light source and fruit packer sequentially;

wherein the packaging film is a MAP film, wherein the MAP film has an oxygen transmission rate (OTR) of about 8000 cc/m²/day to about 17500 cc/m²/day.

Shelf Life

Shelf life can be defined as the length of time a product remains fit for sale or consumption. A number of factors can contribute to whether a product remains fit for sale or consumption. These include fruit softness (or firmness), fruit flavour, fruit aroma, and the development of disease such as rots.

The terms “increasing the shelf life” and “increase in shelf life” as used herein refer to the shelf life of the fruit packaged according to the method of the present invention being increased when compared to UV treated fruit packaged in a film (such as a needle-perforated film) which does not modify the levels of O₂ and CO₂ within the packaging film during storage; other factors such as age, time from harvest, storage temperature and the type and size code of the fruit are the same.

In some embodiments, the term “packaged fruit” refers to the fruit packaged according to the method of the present invention.

In some embodiments, the shelf life of the packaged fruit is increased by at least 1 day, 2 days, 3 days, 4 days, 5 days, or 6 days when the packaged fruit is stored at a chilled temperature.

In some embodiments, the shelf life of the packaged fruit is increased by at least 1 day, 2 days, 3 days, 4 days, 5 days, or 6 days when the packaged fruit is stored at an ambient temperature.

In some embodiments, the shelf life of the packaged fruit is increased by at least 1 day, 2 days, 3 days, 4 days, 5 days, or 6 days when the packaged fruit is first stored at a chilled temperature followed by storage at an ambient temperature.

In some embodiments, the softening of the fruit is reduced.

Softening of fruit occurs as the fruit ripens. Softening of fruit, or ripeness, is often measured by testing the firmness of the surface of a fruit. Typically the firmness of the surface of a fruit is tested with a penetrometer. The term “firmness” as used herein may be used interchangeably with the term “pressure”.

Suitable penetrometers are well known in the art, for example the Fruit Texture Analyser (FTA) (Ace Industrial Supplies Limited). Such penetrometers can measure using a variety of different probes and are suitable for measuring the firmness of many different fruits.

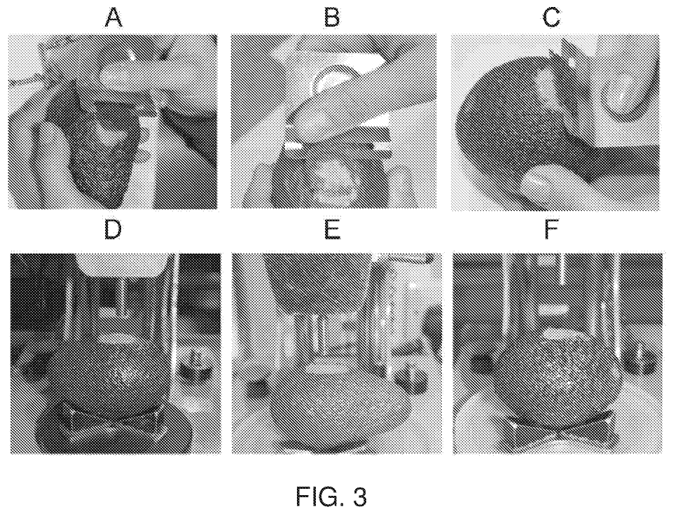

In some embodiments, the penetrometer is used with a probe which measures the pressure to a depth of about 7 mm. Referring to FIG. 3, panels A-C exemplify ways in which the skin can be removed from the fruit—for example with a peeler. In some embodiments, the peeler has no greater than a 1.5 mm depth (such that it reduces the risk of the blade digging into the fruit). The fruit should be peeled on opposite sides at the widest part of the bulb circumference such that flesh is visible on both sides. Panels D-F show the measurement of the firmness with an FTA equipped with a flat probe with a depth of about 7 mm and a diameter of about 8 mm. Typically the probe penetrates the fruit at about a 90 degree angle to the surface of de-skinned area (while using the cradle to position and stabilise the fruit). Readings are taken from both deskinned sides, and are repeated to give a reading for the fruit.

The term “softening of the fruit is reduced” as used herein refers to the fruit packaged according to the method of the present invention having a lower reduction in firmness when compared to the firmness of UV treated fruit packaged in a film (such as a needle-perforated film) which does not modify the levels of O₂ and CO₂ within the packaging film during storage; other factors such as age, time from harvest, storage temperature and the type and size code of the fruit are the same.

In some embodiments, the fruit has a reduction in firmness of no more than about 45% after storage at a chilled temperature for 1, 2, 3, 4, 5, 6, 7, 8, 9, 10, 11 or 12 days post-packaging. In some embodiments, the fruit has a reduction in firmness of no more than about 40% after storage at a chilled temperature for 1, 2, 3, 4, 5, 6, 7, 8, 9, 10, 11 or 12 days post-packaging. In some embodiments, the fruit has a reduction in firmness of no more than about 35% after storage at a chilled temperature for 1, 2, 3, 4, 5, 6, 7, 8, 9, 10, 11 or 12 days post-packaging. In some embodiments, the fruit has a reduction in firmness of no more than about 30% after storage at a chilled temperature for 1, 2, 3, 4, 5, 6, 7, 8, 9, 10, 11 or 12 days post-packaging. In some embodiments, the fruit has a reduction in firmness of no more than about 25% after storage at a chilled temperature for 1, 2, 3, 4, 5, 6, 7, 8, 9, 10, 11 or 12 days post-packaging. In some embodiments, the fruit has a reduction in firmness of no more than about 20% after storage at a chilled temperature for 1, 2, 3, 4, 5, 6, 7, 8, 9, 10, 11 or 12 days post-packaging. In some embodiments, the fruit has a reduction in firmness of no more than about 18% after storage at a chilled temperature for 1, 2, 3, 4, 5, 6, 7, 8, 9, 10, 11 or 12 days post-packaging. In some embodiments, the fruit has a reduction in firmness of no more than about 15% after storage at a chilled temperature for 1, 2, 3, 4, 5, 6, 7, 8, 9, 10, 11 or 12 days post-packaging.

In some embodiments, the fruit has a reduction in firmness of no more than about 60% after storage at an ambient temperature for 1, 2, 3, 4, 5, 6, 7, 8, 9, 10, 11 or 12 days post-packaging. In some embodiments, the fruit has a reduction in firmness of no more than about 55% after storage at an ambient temperature for 1, 2, 3, 4, 5, 6, 7, 8, 9, 10, 11 or 12 days post-packaging. In some embodiments, the fruit has a reduction in firmness of no more than about 50% after storage at an ambient temperature for 1, 2, 3, 4, 5, 6, 7, 8, 9, 10, 11 or 12 days post-packaging. In some embodiments, the fruit has a reduction in firmness of no more than about 40% after storage at an ambient temperature for 1, 2, 3, 4, 5, 6, 7, 8, 9, 10, 11 or 12 days post-packaging. In some embodiments, the fruit has a reduction in firmness of no more than about 35% after storage at an ambient temperature for 1, 2, 3, 4, 5, 6, 7, 8, 9, 10, 11 or 12 days post-packaging. In some embodiments, the fruit has a reduction in firmness of no more than about 30% after storage at an ambient temperature for 1, 2, 3, 4, 5, 6, 7, 8, 9, 10, 11 or 12 days post-packaging. In some embodiments, the fruit has a reduction in firmness of no more than about 25% after storage at an ambient temperature for 1, 2, 3, 4, 5, 6, 7, 8, 9, 10, 11 or 12 days post-packaging. In some embodiments, the fruit has a reduction in firmness of no more than about 20% after storage at an ambient temperature for 1, 2, 3, 4, 5, 6, 7, 8, 9, 10, 11 or 12 days post-packaging. In some embodiments, the fruit has a reduction in firmness of no more than about 18% after storage at an ambient temperature for 1, 2, 3, 4, 5, 6, 7, 8, 9, 10, 11 or 12 days post-packaging. In some embodiments, the fruit has a reduction in firmness of no more than about 15% after storage at an ambient temperature for 1, 2, 3, 4, 5, 6, 7, 8, 9, 10, 11 or 12 days post-packaging.

In some embodiments, the fruit has a reduction in firmness of no more than about 60% after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In some embodiments, the fruit has a reduction in firmness of no more than about 55% after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In some embodiments, the fruit has a reduction in firmness of no more than about 50% after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In some embodiments, the fruit has a reduction in firmness of no more than about 40% after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In some embodiments, the fruit has a reduction in firmness of no more than about 35% after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In some embodiments, the fruit has a reduction in firmness of no more than about 30% after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In some embodiments, the fruit has a reduction in firmness of no more than about 25% after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In some embodiments, the fruit has a reduction in firmness of no more than about 20% after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In some embodiments, the fruit has a reduction in firmness of no more than about 18% after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In some embodiments, the fruit has a reduction in firmness of no more than about 15% after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging.

The time it takes for a rot (such as stem end rot and/or anthracnose) or the signs of bruising to develop is directly related to the shelf life performance of a fruit such as avocado.

In some embodiments, the incidence of rot in the packaged fruit is reduced. Typically, rotting affects the firmness of the fruit. The rot may be selected from the group consisting of lenticel rot, external body rot, internal body rot, stem end rot, anthracnose and combinations thereof. Major post-harvest diseases are stem end rot and anthracnose (The Avocado Botany, Production and Uses 2^{nd} Edition. Edited by Bruce Schaffer, B. Nigel Wolstenholme and Anthony W. Whiley page 493). In some embodiments, the rot is stem end rot and/or anthracnose.

Stem end rot is a common rot occurring in tropical fruits such as mango and avocado. A range of different fungi can cause stem end rot including various anamorphs of Botyosphaeria spp., Thyronectria pseudotrichia, Colletotrichum gloeosporioides, Phomopsis perseae Zerova and Fusarium decemcellulare. Other organisms, including Fusarium sambucinum, Fusarium solani, Pestalotiopsis versicolor, Bipolaris setariae and Rhizopus stolonifer are occasionally associated with the disease. The symptoms of stem end rot include the development of a dark rot from the stem end as fruit ripen after harvest. A dark brown to black rot may begin at the stem end as a dark brown ring and the rot proceeds towards the other end. The rot can produce dark streaking of the water-conducting tissues (this symptom distinguishes stem end rot from anthracnose diseases). Avocado fruit stem-end rots are usually not obvious while fruit is on the tree. Infections usually become active after the fruit is picked and starts to soften. Harvesting can injure the fruit around the button, and bacteria and fungi can enter the freshly cut stem, causing decay as fruit ripens.

Anthracnose is a common rot occurring in fruits such as melon, tomato, passionfruit mango and avocado. Anthracnose is caused by the fungus Colletotrichum gloeosporioides. Anthracnose of avocado fruit is usually not obvious before ripening. Anthracnose symptoms can develop on flowers, fruit, leaves, or twigs. Before harvest, brown to black lesions less than 0.2 inch (5 mm) in diameter may develop around lenticels on infected fruit. These small discolorations can be overlooked while the fruit are still on the tree, and the lesions usually do not enlarge until the fruit ripens after harvest. Some fruits, however, appear to have no blemishes at the time of harvest. Further, the external symptoms may be difficult to see on fruit such as ripe ‘Hass’ avocados because of its dark skin colour. After harvest, the lesions become blacker, larger, and increasingly sunken. The lesions eventually spread over the entire fruit surface and throughout pulp. Typically, the lesions expand rapidly within just one or two days, as the fruit ripen.

Thus in one aspect the present invention may reduce the incidence of rot in the packaged fruit.

The terms “incidence of rot in the packaged fruit is reduced” and “reduce the incidence of rot” as used herein refer to the fruit packaged according to the method of the present invention as having a lower incidence of rot when compared to the incidence of rot of UV treated fruit packaged in a film (such as a needle-perforated film) which does not modify the levels of O₂ and CO₂ within the packaging film during storage; other factors such as age, time from harvest, storage temperature and the type and size code of the fruit are the same.

The incidence of rot in the packaged fruit on any given day post-packaging may be reduced by at least 50%, 60%, 70%, 80% or 90%. In one aspect, the incidence of rot in the packaged fruit on day 4 or day 6 or day 8 or day 9 or day 10 or day 12 is reduced by at least 50%, 60%, 70%, 80% or 90%. In a further aspect, the incidence of rot in the packaged fruit on day 4 or day 6 or day 8 or day 9 or day 10 or day 12 is reduced by at least 50%, 60%, 70%, 80% or 90% when the fruit is stored at a chilled temperature.

Fruit

In some embodiments the fruit is avocado.

Examples of avocado cultivars include, but are not limited to Hass, Natures Hass, Muluma Hass, Lamb Hass, Gem®, Carmen, Fuerte, Pinkerton, Ryan, Reed, Linda, Carla, Ettinger, Lula, Semil, Bacon, Gwen, Zutano, Jim, Susan, Rincon, Clifton, Covacado, Duke, Henry, Select, Jalna, Leucadia, Santana, Teague, 287, Anaheim, Benik, Bonita, Carlsbad, Dickinson, Edranol, Elsie, Ryan, ltzamna, MacArthur, Nabal, Queen, and Thille.

In some embodiments the avocado is an avocado cultivar selected from the group consisting of Hass, Natures Hass, Muluma Hass, Lamb Hass, Gem®, Carmen, Fuerte, Pinkerton, Ryan, Reed, Linda, Carla, Ettinger, Lula, Semil, Bacon, Gwen, Zutano, and combinations thereof.

In one aspect, the fruit is a Hass avocado. In a further aspect, the fruit is a GEM® avocado. In another aspect, the fruit is a Fuerte avocado.

GEM® is an avocado cultivar which is available from the University of California, Riverside, Calif., USA.

Table A shows the weight of avocados categorised as any one of size codes 6 to 32.

TABLE A

| Avocado Size Code | Minimum weight (g) | Maximum weight (g) |
|---|---|---|
| 6 | 576 | 780 |
| 8 | 456 | 576 |
| 10 | 364 | 462 |
| 12 | 300 | 371 |
| 14 | 258 | 313 |
| 16 | 227 | 274 |
| 18 | 203 | 243 |
| 20 | 184 | 217 |
| 22 | 165 | 196 |
| 24 | 151 | 175 |
| 26 | 144 | 157 |
| 28 | 134 | 147 |
| 30 | 123 | 137 |
| 32 | 80 | 123 |

Typically ripen-at-home avocados range from size code 26 to 32.

Traditionally fruit has been packaged “unripe”.

In some embodiments, the fruit is a ripen-at-home fruit.

The term “ripen-at-home fruit” as used herein refers to a triggered fruit (such as an avocado) which is not a fully ripe fruit but is one whereby the ripening process has been initiated (in other words, the ripening process has been triggered) but then slowed down, close to a stop. The ripening process can be initiated (or triggered) by increasing the temperature at which the fruit is stored and exposing the fruit to ethylene. The ripening process can be slowed down close to a stop by using, for example, a low temperature suitable for the fruit and cultivar or 1-methylcyclopropene (1-MCP). The customer has the choice to ripen the product, when they want to, after they have purchased the fruit.

Without wishing to be bound by theory, 1-MCP slows down the ripening process by blocking the effect of ethylene through preferential attachment to the ethylene receptor; 1-MCP can inhibit ripening by as much as 1 year. SmartFresh® can cause ripening issues so that the fruit (e.g. avocado) does not ripen.

In some embodiments, the fruit has not been treated postharvest with 1-methylcyclopropene (1-MCP) (such as SmartFresh®, AgroFresh).

As an alternative to treating fruit with 1-MCP, the fruit can be transported at a low temperature suitable for the fruit and cultivar. Optimum storage temperatures for Hass avocados are typically 5° C. to 7° C. for early season fruit and 2.5° C. to 4° C. for late season fruit.

The term “season” may be used interchangeably with the term “growing season”.

The term “early season” refers to the first third of the growing season. The term “middle of the season” refers to the second third of the growing season. The term “late season” refers to the final third of the growing season.

Pressures for a “ripen-at-home” fruit for sale to customers typically range from about 3.6 kg to about 11.8 kg.

There is a growing consumer demand for ripe and “ready-to-eat” fruit, such that the fruit does not require further ripening during storage by the consumer and can be consumed (with a satisfactory taste) immediately. In other words, the ready-to-eat fruit has already undergone a ripening process.

In some embodiments, the fruit is a ready-to-eat fruit.

The term “ready-to-eat fruit” as used herein refers to a fruit that does not require further ripening by the consumer after purchase.

Pressures for a “ready-to-eat” fruit typically range from about 0.23 kg to about 3.2 kg. In some embodiments, the pressure for a “ready-to-eat” fruit is in a range of about 1 lb (0.45 kg) to about 4 lb (1.8 kg).

In some embodiments, the fruit is grown in South Africa. In some embodiments, the fruit is an avocado grown in South Africa. In some embodiments, the fruit is a late season avocado grown in South Africa. In some embodiments, the fruit is a late season Hass avocado grown in South Africa.

Dry-Matter Content

The term “dry-matter” as used herein is the ratio of the dried mass to the fresh mass of a sampled mesocarp portion of the fruit (such as avocado).

The cultivar, cultural practices, season, production location (i.e. the country and/or growing area within the country) and micro environment and macro environment can influence the relationship between fruit oil content, percentage dry-matter (% DM) and fruit quality (The Avocado Botany, Production and Uses 2^{nd} Edition. Edited by Bruce Schaffer, B. Nigel Wolstenholme and Anthony W. Whiley page 496).

In some countries, one standard minimum percentage dry-matter content for harvesting is required for different avocado cultivars and production locations. In some countries the standard percentage dry-matter content for harvesting depends on the cultivar. For instance, in South Africa, export regulations require the percentage dry-matter of all avocado cultivars is greater than 20% to prevent uneven ripening and shrivelling—the exceptions are that the cultivars “Hass” and “Ryan” must have a percentage dry-matter of greater than 23%, and the cultivar “Edranol” must have a percentage dry-matter of greater than 25%. (The Avocado Botany, Production and Uses 2^{nd} Edition. Edited by Bruce Schaffer, B. Nigel Wolstenholme and Anthony W. Whiley page 496.) All growers and receivers work to the same standard.

Table B shows the minimum dry-matter weight that avocados varieties may be expected to have reached in the USA before they are commercially harvested and sold to the public.

TABLE B

| Dry-Matter % | Avocado varieties |
|---|---|
| 17.7 | Bacon |
| 19.0 | Fuerte |
| 18.7 | Zutano |
| 21.6 | Pinkerton |
| 20.8 | Hass |
| 19.3 | Jim |
| 18.4 | Susan |
| 20.4 | Rincon |
| 24.2 | Gwen |
| 18.7 | Reed |
| 18.7 | Clifton, Covacado, Duke, Henry, Select, Jalna, |
| | Leucadia, Santana, Teague, 287, other fall/winter |
| | varieties. |
| 20.8 | Anaheim, Benik, Bonita, Carlsbad, Dickinson, Edranol, |
| | Elsie, Ryan, Itzamna, MacArthur, Nabal, Queen, Thille, |
| | other spring/summer varieties. |

Avocados at the start and middle of a season typically have a lower dry-matter content (typically between 23% and 32% for Hass). Generally, the dry-matter content of a fruit increases as the fruit growing season progresses. Towards the end of the season, avocados have a high dry-matter content. One exception is that in some environments, avocados can be held on the tree for one year or more after physiological maturity. Such avocados will typically have a high dry-matter content but could be harvested at what appears to be the start or middle of the season but is, in fact, the subsequent season.

The South African growing season for avocados typically starts in March and typically finishes in November or December. Typically the late season starts from September. The start and the end of a season can be affected by the climate such as the amount of rainfall and/or the temperature. Fruit which has a high dry-matter content, as typically found towards the end of the fruit season, needs to be transported at much lower temperatures than fruit at the beginning and middle of the season which has a low dry-matter content. Thus transportation costs are higher for fruit with a high dry-matter content.

The respiration rate of the avocados with low dry-matter levels (typically between 23% and 32% for Hass), perform as expected; whereby the ripening process is initiated (and thus the respiration rate of the avocado is increased) and then slowed down (and thus the respiration rate is decreased), without issue. Typically this allows for a shelf life of “Display Until” 6 to 8 days post-packaging when stored at a chilled temperature.

“Best before” dates are about the quality of the food rather than the safety of the food. When the “best before” date expires it does not mean that the food will be harmful, however the food might begin to lose its flavour and/or texture. “Display until” or “sell by” dates often appear near or next to the “best before” date and are used by some shops to help with stock control and are instructions for shop staff, not customers.

The typical shelf life of ripen-at-home avocados is “Display until” 6 days post-packaging when stored at a chilled temperature. However, the typical shelf-life of ripen-at-home avocados with high levels of dry-matter is “Display until” 4 days post-packaging when stored at a chilled temperature.

As the levels of dry-matter in avocados increase (such as above 32% for Hass), it becomes increasingly difficult to control the respiration rate of the fruit (i.e. slow it down), which results in the fruit ripening too quickly and reaching senescence before the end of the “Display Until” date (set for fruit with lower levels of dry-matter)—this results in dissatisfied customers. Prior to the present invention, the only way to manage this customer dissatisfaction was to reduce the shelf life of the product (e.g. reduce the “Display Until” post-packaging date)—this increases the amount of wastage (especially during periods of low sales). In addition to the subsequent disposal of rotten fruit, this is also costly in monetary terms for the retailer. Surprisingly, by using a modified atmosphere packaging (MAP) film having an oxygen transmission rate (OTR) of up to about 19500 cc/m²/day, preferably up to about 17500 cc/m²/day, in combination with UV treatment of the fruit, a slower respiration rate is maintained in fruit with high levels of dry-matter (especially in RAH avocados), thus there is no need to reduce the “Display Until” date; thus the shelf life is increased when compared to UV treated fruit packaged in a film (such as a needle-perforated film) which does not modify the atmosphere (such as the levels of O₂ and CO₂) within the packaging film during storage (other factors such as age, time from harvest, storage temperature and the type and size code of the fruit are the same).

There is a close relationship between the oil content and the development of an avocado fruit; the oil content increases as the fruit matures. As the oil content of an avocado increases, the amount of water in the fruit decreases. Thus, the maturity of an avocado can be based on the percentage of dry-matter content.

The dry-matter content of a fruit is typically determined in the field before harvesting commences. The harvest will not start if the dry-matter levels are found below the minimum requirement.

The dry-matter content of a fruit, such as an avocado, may be determined as follows: cut the fruit into chunks and remove the skin to obtain the mesocarp; weigh the mesocarp to obtain the wet weight; place the mesocarp sample into a drying apparatus (such as an oven), set the drying apparatus to a high temperature and bake until dry (i.e. until no further reduction in weight loss is observed) such as 4 hours at 105° C.; and weigh the dried sample. The percentage dry-matter is calculated as:

(Dry weight/wet weight)×100

In some embodiments, the term “high dry-matter” as used herein refers to a fruit, such as an avocado, with a level of dry-matter which makes it is difficult to control the ripening process of the fruit by, for example, refrigeration and/or UV treatment.

In some embodiments, the term “high dry-matter” as used herein refers to a fruit, such as an avocado, wherein the level of dry-matter of the fruit is at least 10%, 20%, 25%, 30%, 35%, 40%, 45% or 50% higher than the level of dry-matter of the fruit at the start of the season (the early season). This is based on a comparison of the average dry-matter level of a sample of fruit (such as at least 10 fruit) taken at the beginning of the season (the early season) and the average dry-matter level of a sample of fruit (such as at least 10 fruit) taken later on in the season (such as the middle season or late season); other factors such the cultivar and size code of the fruit are the same.

In some embodiments the fruit has a dry-matter content of at least 26%, 28%, 30%, 32% or 34%. In some aspects, the fruit has a dry-matter content of at least 32% or 34%.

In some embodiments, the term “high dry-matter” as used herein refers to a Hass avocado with a dry-matter content of at least 32% or 34%.

In some embodiments, the term “high dry-matter” as used herein refers to a Gem® avocado with a dry-matter content of at least 26%, 28%, 30%, 32% or 34%.

In some embodiments, the term “high dry-matter” as used herein refers to a Fuerte avocado with a dry-matter content of at least 26%, 28%, 30%, 32% or 34%.

In some embodiments, the term “high dry-matter” as used herein refers to an Edranol avocado with a dry-matter content of at least 32% or 34%.

UV Light

Sources of UV radiation or light are well known in the art, for example UV lamps or boxes. UV light denotes ultraviolet light in a wavelength range of approximately less than 310 nm. UV light is further divided into specific bands, including UV-C. UV-C denotes ultraviolet light in the C band; i.e., ultraviolet radiation having a wavelength in a range of approximately 220 to 290 nanometers (nm), and more particularly approximately 250 to 280 nm, and even more particularly approximately 265 nm. UV light is known to cause damage to DNA and through this function is able to inactivate disease causing pathogens (such as E. coli, for instance E. coli 1571) and food-spoilage microorganisms on the irradiated surface.

In some embodiments, the method comprises a step of positioning the fruit in a holder such that the stem faces the UV light source during the treatment with UV light.

In some embodiments the fruit is treated with UV light before and/or during and/or after packaging the fruit.

In some embodiments the UV light is UV-C light.

In some embodiments, the UV light has a wavelength of between about 100 nm and about 280 nm, or between about 200 nm and about 270 nm, or between about 240 nm and about 270 nm, or between about 250 nm and about 260 nm, or about 254 nm.

In some aspects, the UV light has a wavelength of about 254 nm.

In other aspects, the UV light has a wavelength of between about 100 nm and about 240 nm. Without wishing to be bound by theory, using UV light with a wavelength of between about 100 nm and about 240 nm generates ozone in the modified atmosphere within the packaging film of the packaged fruit.

It is also known that the duration of the exposure to the UV light, and the distance between the irradiated object and UV source, affects the overall dosage.

Thus in some aspects the fruit is exposed to the UV light for about 1 to about 10 seconds, or about 1 to about 5 seconds. In some embodiments, the fruit is exposed to the UV light for about 3 seconds.

In some aspects, the distance between the source of UV light and the fruit is about 10 mm to about 100 mm, or about 30 mm to about 70 mm, or about 50 mm.

In some embodiments, the fruit is treated with a dose of UV light in the range of about 20 mJ/cm² to about 40 mJ/cm², or about 25 mJ/cm² to about 35 mJ/cm², or about 30 mJ/cm².

Packaging

Air comprises about 21% oxygen and 79% nitrogen, with trace concentrations of other gases such as carbon dioxide and noble gases. MAP (modified atmosphere packaging) describes any process for replacing the air within the packaging film (i.e. the package) with another gas or gas mixture, and is commonly used for the extension of the shelf life for a variety of consumable products such as fruits and vegetables.

In one aspect, the modified atmosphere is created by a process whereby the air within an unsealed package is flushed with the desired gas or gas mixture before the package is sealed with the new gas or gas mixture in the package.

The term “modified atmosphere within the packaging film” as used herein refers to the atmosphere within the package of a packaged fruit being modified such that the gases within the package are not in the proportions as they would be in air (for example, the proportion of oxygen within the packaging is not 21% and the proportion of carbon dioxide within the packaging is not a trace such as 0.1%).

The terms “within the packaging film”, “within the package” and “headspace” may be used interchangeably herein.

A modified atmosphere can also be created passively when products comprising living tissue and cells (such as fruits and vegetables) are packaged. Living tissue and cells continue to respire in the package and through this biological process consume oxygen and release carbon dioxide. Packaging films can be made such that the permeability to certain gases such as oxygen is reduced or increased relative to other gases, and thus will over time alter the composition of gases in the package when used in conjunction with a fruit that continues to respire. Such packaging film can be defined as “MAP film”. Modifying the atmosphere in such a way to reduce the respiration of the packaged fruit can enhance the fruit's shelf life.

In some embodiments, the modified atmosphere within the packaging film is due to the use of a MAP film.

OTR (oxygen transmission rate) is the steady state rate at which oxygen gas permeates through a film at specified conditions of temperature and relative humidity (RH). Standard test conditions are 73° F. (23° C.) and 0% RH.

In some embodiments, the MAP film has an oxygen transmission rate (OTR) of at least about 8000 cc/m²/day.

In some embodiments, the MAP film has an oxygen transmission rate (OTR) of about 8000 cc/m²/day to about 25000 cc/m²/day. In some embodiments, the MAP film has an oxygen transmission rate (OTR) of about 8000 cc/m²/day to about 22500 cc/m²/day. In some embodiments, the MAP film has an oxygen transmission rate (OTR) of about 8000 cc/m²/day to about 20000 cc/m²/day.

In some embodiments, the MAP film has an oxygen transmission rate (OTR) of at least about 12000 cc/m²/day.

In some embodiments, the MAP film has an oxygen transmission rate (OTR) of about 12000 cc/m²/day to about 25000 cc/m²/day. In some embodiments, the MAP film has an oxygen transmission rate (OTR) of about 12000 cc/m²/day to about 22500 cc/m²/day. In some embodiments, the MAP film has an oxygen transmission rate (OTR) of about 12000 cc/m²/day to about 20000 cc/m²/day.

In some embodiments, the MAP film has an oxygen transmission rate (OTR) up to about 19500 cc/m²/day.

In some embodiments, the MAP film has an oxygen transmission rate (OTR) of about 8000 cc/m²/day to about 19500 cc/m²/day. In some embodiments, the MAP film has an oxygen transmission rate (OTR) of about 9000 cc/m²/day to about 19500 cc/m²/day. In some embodiments, the MAP film has an oxygen transmission rate (OTR) of about 10000 cc/m²/day to about 19500 cc/m²/day. In some embodiments, the MAP film has an oxygen transmission rate (OTR) of about 11000 cc/m²/day to about 19500 cc/m²/day. In some embodiments, the MAP film has an oxygen transmission rate (OTR) of about 12000 cc/m²/day to about 19500 cc/m²/day.

In some embodiments, the MAP film has an oxygen transmission rate (OTR) up to about 18000 cc/m²/day.

In some embodiments, the MAP film has an oxygen transmission rate (OTR) of about 8000 cc/m²/day to about 18000 cc/m²/day. In some embodiments, the MAP film has an oxygen transmission rate (OTR) of about 9000 cc/m²/day to about 18000 cc/m²/day. In some embodiments, the MAP film has an oxygen transmission rate (OTR) of about 10000 cc/m²/day to about 18000 cc/m²/day. In further embodiments, the MAP film has an oxygen transmission rate (OTR) of about 11000 cc/m²/day to about 18000 cc/m²/day. In other embodiments, the MAP film has an oxygen transmission rate (OTR) of about 12000 cc/m²/day to about 18000 cc/m²/day.

In some embodiments, the MAP film has an oxygen transmission rate (OTR) up to about 17500 cc/m²/day.

In some embodiments, the MAP film has an oxygen transmission rate (OTR) of about 8000 cc/m²/day to about 17500 cc/m²/day. In some embodiments, the MAP film has an oxygen transmission rate (OTR) of about 9000 cc/m²/day to about 17500 cc/m²/day. In some embodiments, the MAP film has an oxygen transmission rate (OTR) of about 10000 cc/m²/day to about 17500 cc/m²/day. In some embodiments, the MAP film has an oxygen transmission rate (OTR) of about 11000 cc/m²/day to about 17500 cc/m²/day. In some embodiments, the MAP film has an oxygen transmission rate (OTR) of about 12000 cc/m²/day to about 17500 cc/m²/day.

In some embodiments, the MAP film has an oxygen transmission rate (OTR) up to about 17000 cc/m²/day.

In some embodiments, the MAP film has an oxygen transmission rate (OTR) of about 8000 cc/m²/day to about 17000 cc/m²/day. In some embodiments, the MAP film has an oxygen transmission rate (OTR) of about 9000 cc/m²/day to about 17000 cc/m²/day. In some embodiments, the MAP film has an oxygen transmission rate (OTR) of about 10000 cc/m²/day to about 17000 cc/m²/day. In some embodiments, the MAP film has an oxygen transmission rate (OTR) of about 11000 cc/m²/day to about 17000 cc/m²/day. In other embodiments, the MAP film has an oxygen transmission rate (OTR) of about 12000 cc/m²/day to about 17000 cc/m²/day.

In further embodiments, the MAP film has an oxygen transmission rate (OTR) of about 12000 cc/m²/day to about 16000 cc/m²/day. In further embodiments, the MAP film has an oxygen transmission rate (OTR) of about 12000 cc/m²/day to about 15000 cc/m²/day. In further embodiments, the MAP film has an oxygen transmission rate (OTR) of about 12000 cc/m²/day to about 14500 cc/m²/day.

In some embodiments, the MAP film has an oxygen transmission rate (OTR) of at least about 13000 cc/m²/day.

In further embodiments, the MAP film has an oxygen transmission rate (OTR) of about 13000 cc/m²/day to about 17500 cc/m²/day. In further embodiments, the MAP film has an oxygen transmission rate (OTR) of about 13000 cc/m²/day to about 17000 cc/m²/day. In further embodiments, the MAP film has an oxygen transmission rate (OTR) of about 13000 cc/m²/day to about 16000 cc/m²/day. In further embodiments, the MAP film has an oxygen transmission rate (OTR) of about 13000 cc/m²/day to about 15000 cc/m²/day. In further embodiments, the MAP film has an oxygen transmission rate (OTR) of about 13000 cc/m²/day to about 14500 cc/m²/day.

In some embodiments, the MAP film has an oxygen transmission rate (OTR) of at least about 14000 cc/m²/day.

In further embodiments, the MAP film has an oxygen transmission rate (OTR) of about 14000 cc/m²/day to about 17500 cc/m²/day. In further embodiments, the MAP film has an oxygen transmission rate (OTR) of about 14000 cc/m²/day to about 17000 cc/m²/day. In some embodiments, the MAP film has an oxygen transmission rate (OTR) of about 14000 cc/m²/day to about 16000 cc/m²/day. In some embodiments, the MAP film has an oxygen transmission rate (OTR) of about 14000 cc/m²/day to about 15000 cc/m²/day. In some embodiments, the MAP film has an oxygen transmission rate (OTR) of about 14000 cc/m²/day to about 14500 cc/m²/day. In other embodiments, the MAP film has an oxygen transmission rate (OTR) of about 14300 cc/m²/day.

In some embodiments, the fruit is a ripen-at-home avocado and the MAP film has an OTR of about 8000 cc/m²/day to about 45000 cc/m²/day. In some embodiments, the fruit is a ripen-at-home avocado and the MAP film has an OTR of about 12000 cc/m²/day to about 45000 cc/m²/day. In some embodiments, the fruit is a ripen-at-home avocado and the MAP film has an OTR of about 14000 cc/m²/day to about 40000 cc/m²/day. In some embodiments, the fruit is a ripen-at-home avocado and the MAP film has an OTR of about 14000 cc/m²/day to about 38000 cc/m²/day. In some embodiments, the fruit is a ripen-at-home avocado and the MAP film has an OTR of about 38000 cc/m²/day.

In some embodiments, the fruit is a ripen-at-home avocado and the packaged fruit is stored at an ambient temperature and the MAP film has an OTR of about 8000 cc/m²/day to about 45000 cc/m²/day. In some embodiments, the fruit is a ripen-at-home avocado and the packaged fruit is stored at an ambient temperature and the MAP film has an OTR of about 12000 cc/m²/day to about 45000 cc/m²/day. In some embodiments, the fruit is a ripen-at-home avocado and the packaged fruit is stored at an ambient temperature and the MAP film has an OTR of about 14000 cc/m²/day to about 40000 cc/m²/day. In some embodiments, the fruit is a ripen-at-home avocado and the packaged fruit is stored at an ambient temperature and the MAP film has an OTR of about 14000 cc/m²/day to about 38000 cc/m²/day. In some embodiments, the fruit is a ripen-at-home avocado and the packaged fruit is stored at an ambient temperature and the MAP film has an OTR of about 38000 cc/m²/day.

In some embodiments, the fruit is a ripen-at-home avocado, wherein the fruit has a high dry-matter content, and the packaged fruit is stored at an ambient temperature and the MAP film has an OTR of about 8000 cc/m²/day to about 45000 cc/m²/day. In some embodiments, the fruit is a ripen-at-home avocado, wherein the fruit has a high dry-matter content, and the packaged fruit is stored at an ambient temperature and the MAP film has an OTR of about 12000 cc/m²/day to about 45000 cc/m²/day. In some embodiments, the fruit is a ripen-at-home avocado, wherein the fruit has a high dry-matter content, and the packaged fruit is stored at an ambient temperature and the MAP film has an OTR of about 14000 cc/m²/day to about 40000 cc/m²/day. In some embodiments, the fruit is a ripen-at-home avocado, wherein the fruit has a high dry-matter content, and the packaged fruit is stored at an ambient temperature and the MAP film has an OTR of about 14000 cc/m²/day to about 38000 cc/m²/day. In some embodiments, the fruit is a ripen-at-home avocado, wherein the fruit has a high dry-matter content, and the packaged fruit is stored at an ambient temperature and the MAP film has an OTR of about 38000 cc/m²/day.

In some embodiments, the modified atmosphere within the packaging film has a reduced O₂ concentration compared to the environment surrounding the packaged fruit.

In some embodiments, the modified atmosphere within the packaging film has an increased CO₂ concentration compared to the environment surrounding the packaged fruit.

In some aspects, the modified atmosphere within the packaging film comprises from about 6% to about 20% O₂ after 2 days or 4 days or 6 days or 8 days or 10 days post-packaging storage at a chilled temperature. In other aspects, the modified atmosphere within the packaging film comprises from about 6% to about 18% O₂ after 2 days or 4 days or 6 days or 8 days or 10 days post-packaging storage at a chilled temperature. In other aspects, the modified atmosphere within the packaging film comprises from about 8% to about 14% O₂ after 2 days or 4 days or 6 days or 8 days or 10 days post-packaging storage at a chilled temperature. In other aspects, the modified atmosphere within the packaging film comprises from about 9% to about 13% O₂ after 2 days or 4 days or 6 days or 8 days or 10 days post-packaging storage at a chilled temperature. In other aspects, the modified atmosphere within the packaging film comprises from about 10% to about 12% O₂ after 2 days or 4 days or 6 days or 8 days or 10 days post-packaging storage at a chilled temperature.

In some aspects, the modified atmosphere within the packaging film comprises from about 5% to about 15% CO₂ after 2 days or 4 days or 6 days or 8 days or 10 days post-packaging storage at a chilled temperature. In other aspects, the modified atmosphere within the packaging film comprises from about 5% to about 14% CO₂ after 2 days or 4 days or 6 days or 8 days or 10 days post-packaging storage at a chilled temperature. In other aspects, the modified atmosphere within the packaging film comprises from about 6% to about 14% CO₂ after 2 days or 4 days or 6 days or 8 days or 10 days post-packaging storage at a chilled temperature. In other aspects, the modified atmosphere within the packaging film comprises from about 6% to about 13% CO₂ after 2 days or 4 days or 6 days or 8 days or 10 days post-packaging storage at a chilled temperature. In other aspects, the modified atmosphere within the packaging film comprises from about 6% to about 12% CO₂ after 2 days or 4 days or 6 days or 8 days or 10 days post-packaging storage at a chilled temperature. In other aspects, the modified atmosphere within the packaging film comprises from about 7% to about 14% CO₂ after 2 days or 4 days or 6 days or 8 days or 10 days post-packaging storage at a chilled temperature. In other aspects, the modified atmosphere within the packaging film comprises from about 7% to about 13% CO₂ after 2 days or 4 days or 6 days or 8 days or 10 days post-packaging storage at a chilled temperature. In other aspects, the modified atmosphere within the packaging film comprises from about 7% to about 12% CO₂ after 2 days or 4 days or 6 days or 8 days or 10 days post-packaging storage at a chilled temperature. In other aspects, the modified atmosphere within the packaging film comprises from about 8% to about 12% CO₂ after 2 days or 4 days or 6 days or 8 days or 10 days post-packaging storage at a chilled temperature. In other aspects, the modified atmosphere within the packaging film comprises from about 8% to about 11% CO₂ after 2 days or 4 days or 6 days or 8 days or 10 days post-packaging storage at a chilled temperature. In other aspects, the modified atmosphere within the packaging film comprises from about 8% to about 10% CO₂ after 2 days or 4 days or 6 days or 8 days or 10 days post-packaging storage at a chilled temperature.

In some embodiments, the modified atmosphere within the packaging film comprises from about 6% to about 20% O₂ and from about 6% to about 14% CO₂ after 2 days or 4 days or 6 days or 8 days or 10 days post-packaging storage at a chilled temperature.

In some embodiments, the modified atmosphere within the packaging film comprises from about 6% to about 18% O₂ and from about 6% to about 14% CO₂ after 2 days or 4 days or 6 days or 8 days or 10 days post-packaging storage at a chilled temperature.

In some embodiments, the modified atmosphere within the packaging film comprises from about 8% to about 14% O₂ and from about 5% to about 15% CO₂ after 2 days or 4 days or 6 days or 8 days or 10 days post-packaging storage at a chilled temperature.

In some embodiments, the modified atmosphere within the packaging film comprises from about 9% to about 13% O₂ and from about 6% to about 13% CO₂ after 2 days or 4 days or 6 days or 8 days or 10 days post-packaging storage at a chilled temperature.

In some embodiments, the modified atmosphere within the packaging film comprises from about 9% to about 13% O₂ and from about 7% to about 13% CO₂ after 2 days or 4 days or 6 days or 8 days or 10 days post-packaging storage at a chilled temperature.

In some embodiments, the modified atmosphere within the packaging film comprises from about 9% to about 13% O₂ and from about 8% to about 12% CO₂ after 2 days or 4 days or 6 days or 8 days or 10 days post-packaging storage at a chilled temperature.

In some embodiments, the modified atmosphere within the packaging film comprises from about 10% to about 12% O₂ and from about 8% to about 12% CO₂ after 2 days or 4 days or 6 days or 8 days or 10 days post-packaging storage at a chilled temperature.

In some embodiments, the modified atmosphere within the packaging film comprises from about 10% to about 12% O₂ and from about 8% to about 10% CO₂ after 2 days or 4 days or 6 days or 8 days or 10 days post-packaging storage at a chilled temperature.

In some aspects the modified atmosphere within the packaging film comprises from about 4% to about 16% O₂ after 2 days or 4 days or 6 days or 8 days or 10 days post-packaging storage at an ambient temperature. In other aspects, the modified atmosphere within the packaging film comprises from about 5% to about 12% O₂ after 2 days or 4 days or 6 days or 8 days or 10 days post-packaging storage at an ambient temperature. In other aspects, the modified atmosphere within the packaging film comprises from about 6% to about 12% O₂ after 2 days or 4 days or 6 days or 8 days or 10 days post-packaging storage at an ambient temperature. In other aspects, the modified atmosphere within the packaging film comprises from about 6% to about 11% O₂ after 2 days or 4 days or 6 days or 8 days or 10 days post-packaging storage at an ambient temperature. In further aspects, the modified atmosphere within the packaging film comprises from about 6% to about 10% O₂ after 2 days or 4 days or 6 days or 8 days or 10 days post-packaging storage at an ambient temperature. In further aspects, the modified atmosphere within the packaging film comprises from about 6% to about 9% O₂ after 2 days or 4 days or 6 days or 8 days or 10 days post-packaging storage at an ambient temperature. In further aspects, the modified atmosphere within the packaging film comprises from about 6% to about 8% O₂ after 2 days or 4 days or 6 days or 8 days or 10 days post-packaging storage at an ambient temperature. In further aspects, the modified atmosphere within the packaging film comprises from about 6% to about 7% O₂ after 2 days or 4 days or 6 days or 8 days or 10 days post-packaging storage at an ambient temperature. In further aspects, the modified atmosphere within the packaging film comprises from about 7% to about 10% O₂ after 2 days or 4 days or 6 days or 8 days or 10 days post-packaging storage at an ambient temperature. In further aspects, the modified atmosphere within the packaging film comprises from about 7% to about 9% O₂ after 2 days or 4 days or 6 days or 8 days or 10 days post-packaging storage at an ambient temperature. In further aspects, the modified atmosphere within the packaging film comprises from about 7% to about 8% O₂ after 2 days or 4 days or 6 days or 8 days or 10 days post-packaging storage at an ambient temperature. In further aspects, the modified atmosphere within the packaging film comprises about 7% O₂ after 2 days or 4 days or 6 days or 8 days or 10 days post-packaging storage at an ambient temperature.

In some aspects the modified atmosphere within the packaging film comprises from about 6% to about 18% CO₂ after 2 days or 4 days or 6 days or 8 days or 10 days post-packaging storage at an ambient temperature. In some aspects the modified atmosphere within the packaging film comprises from about 6% to about 14% CO₂ after 2 days or 4 days or 6 days or 8 days or 10 days post-packaging storage at an ambient temperature. In some aspects the modified atmosphere within the packaging film comprises from about 6% to about 13% CO₂ after 2 days or 4 days or 6 days or 8 days or 10 days post-packaging storage at an ambient temperature. In other aspects, the modified atmosphere within the packaging film comprises from about 7% to about 17% CO₂ after 2 days or 4 days or 6 days or 8 days or 10 days post-packaging storage at an ambient temperature. In other aspects, the modified atmosphere within the packaging film comprises from about 7% to about 14% CO₂ after 2 days or 4 days or 6 days or 8 days or 10 days post-packaging storage at an ambient temperature. In other aspects, the modified atmosphere within the packaging film comprises from about 7% to about 13% CO₂ after 2 days or 4 days or 6 days or 8 days or 10 days post-packaging storage at an ambient temperature. In other aspects, the modified atmosphere within the packaging film comprises from about 8% to about 14% CO₂ after 2 days or 4 days or 6 days or 8 days or 10 days post-packaging storage at an ambient temperature. In other aspects, the modified atmosphere within the packaging film comprises from about 8% to about 13% CO₂ after 2 days or 4 days or 6 days or 8 days or 10 days post-packaging storage at an ambient temperature. In further aspects, the modified atmosphere within the packaging film comprises from about 9% to about 16% CO₂ after 2 days or 4 days or 6 days or 8 days or 10 days post-packaging storage at an ambient temperature. In further aspects, the modified atmosphere within the packaging film comprises from about 9% to about 14% CO₂ after 2 days or 4 days or 6 days or 8 days or 10 days post-packaging storage at an ambient temperature. In further aspects, the modified atmosphere within the packaging film comprises from about 9% to about 13% CO₂ after 2 days or 4 days or 6 days or 8 days or 10 days post-packaging storage at an ambient temperature. In further aspects, the modified atmosphere within the packaging film comprises from about 10% to about 14% CO₂ after 2 days or 4 days or 6 days or 8 days or 10 days post-packaging storage at an ambient temperature. In further aspects, the modified atmosphere within the packaging film comprises from about 11% to about 14% CO₂ after 2 days or 4 days or 6 days or 8 days or 10 days post-packaging storage at an ambient temperature. In further aspects, the modified atmosphere within the packaging film comprises from about 12% to about 14% CO₂ after 2 days or 4 days or 6 days or 8 days or 10 days post-packaging storage at an ambient temperature. In further aspects, the modified atmosphere within the packaging film comprises from about 13% to about 14% CO₂ after 2 days or 4 days or 6 days or 8 days or 10 days post-packaging storage at an ambient temperature.

In some embodiments, the modified atmosphere within the packaging film comprises from about 6% to about 10% O₂ and from about 6% to about 18% CO₂ after 2 days or 4 days or 6 days or 8 days or 10 days post-packaging storage at an ambient temperature.

In some embodiments, the modified atmosphere within the packaging film comprises from about 6% to about 10% O₂ and from about 9% to about 16% CO₂ after 2 days or 4 days or 6 days or 8 days or 10 days post-packaging storage at an ambient temperature.

In some embodiments, the modified atmosphere within the packaging film comprises from about 6% to about 12% O₂ and from about 6% to about 14% CO₂ after 2 days or 4 days or 6 days or 8 days or 10 days post-packaging storage at an ambient temperature.

In some embodiments, the modified atmosphere within the packaging film comprises from about 6% to about 10% O₂ and from about 9% to about 14% CO₂ after 2 days or 4 days or 6 days or 8 days or 10 days post-packaging storage at an ambient temperature.

In some embodiments, the modified atmosphere within the packaging film comprises from about 6% to about 8% O₂ and from about 11% to about 14% CO₂ after 2 days or 4 days or 6 days or 8 days or 10 days post-packaging storage at an ambient temperature.

In some embodiments, the modified atmosphere within the packaging film comprises from about 6% to about 8% O₂ and from about 11% to about 14% CO₂ after 2 days or 4 days or 6 days or 8 days or 10 days post-packaging storage at an ambient temperature.

In some embodiments, the modified atmosphere within the packaging film comprises from about 6% to about 8% O₂ and from about 12% to about 14% CO₂ after 2 days or 4 days or 6 days or 8 days or 10 days post-packaging storage at an ambient temperature.

In some embodiments, the modified atmosphere within the packaging film comprises from about 6% to about 8% O₂ and from about 13% to about 14% CO₂ after 2 days or 4 days or 6 days or 8 days or 10 days post-packaging storage at an ambient temperature.

In some embodiments, the modified atmosphere within the packaging film comprises about 7% O₂ and from about 13% to about 14% CO₂ after 2 days or 4 days or 6 days or 8 days or 10 days post-packaging storage at an ambient temperature.

In some embodiments, the packaged fruit is first stored at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging.

In some aspects the modified atmosphere within the packaging film comprises from about 4% to about 18% O₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In other aspects, the modified atmosphere within the packaging film comprises from about 5% to about 13% O₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In further aspects, the modified atmosphere within the packaging film comprises from about 6% to about 18% O₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In further aspects, the modified atmosphere within the packaging film comprises from about 6% to about 14% O₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In further aspects, the modified atmosphere within the packaging film comprises from about 6% to about 12% O₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In further aspects, the modified atmosphere within the packaging film comprises from about 7% to about 12% O₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging.

In some aspects the modified atmosphere within the packaging film comprises from about 5% to about 18% CO₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging storage. In other aspects, the modified atmosphere within the packaging film comprises from about 6% to about 17% CO₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In other aspects, the modified atmosphere within the packaging film comprises from about 6% to about 14% CO₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In further aspects, the modified atmosphere within the packaging film comprises from about 7% to about 16% CO₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In further aspects, the modified atmosphere within the packaging film comprises from about 7% to about 14% CO₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging. In further aspects, the modified atmosphere within the packaging film comprises from about 8% to about 14% CO₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging.

In some embodiments, the modified atmosphere within the packaging film comprises from about 6% to about 12% O₂ and from about 7% to about 16% CO₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging.

In some embodiments, the modified atmosphere within the packaging film comprises from about 6% to about 12% O₂ and from about 7% to about 14% CO₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging.

In some embodiments, the modified atmosphere within the packaging film comprises from about 7% to about 12% O₂ and from about 8% to about 14% CO₂ after first storage at a chilled temperature for 1, 2, 3, 4, 5 or 6 days post-packaging followed by storage at an ambient temperature for 1, 2, 3, 4, 5, 6, 7, 8, 9, 10, 11 or 12 days post-packaging.

In some embodiments, the modified atmosphere within the packaging film comprises ozone.

In some embodiments, ozone may be generated within the packaging film of the packaged fruit by use of a UV light (such as a UV light with a wavelength of between about 100 nm and about 240 nm).

In some embodiments, the method comprises a further step of introducing ozone into the modified atmosphere within the packaging film.

In some embodiments, the ozone concentration level in the modified atmosphere within the packaging film is between about 0.25 to about 5 ppm.

In some embodiments, the ozone concentration level in the modified atmosphere within the packaging film is between about 0.25 to about 3 ppm.

In some embodiments, the ozone concentration level in the modified atmosphere within the packaging film is between about 0.4 to about 2.5 ppm.

In some embodiments, the ozone concentration level in the modified atmosphere within the packaging film is between about 0.5 to about 2 ppm.

In some embodiments, the ozone concentration level in the modified atmosphere within the packaging film is between about 0.5 to about 1.5 ppm.

In some embodiments, the ozone concentration level in the modified atmosphere within the packaging film is between about 0.5 to about 1 ppm.

Temperature

In some embodiments, the packaged fruit is stored at a chilled temperature.

In some embodiments, the packaged fruit is stored at about 3° C. to about 10° C. In some embodiments, the packaged fruit is stored at about 3° C. to about 7° C. In some embodiments, the packaged fruit is stored at about 5° C.

In other embodiments, the packaged fruit is stored at an ambient temperature.

In some embodiments, the packaged fruit is stored at ambient temperature from about 14° C. to about 20° C. In some embodiments, the packaged fruit is stored at about 14° C. to about 18° C. In some embodiments, the packaged fruit is stored at about 16° C.

In other embodiments, the packaged fruit is first stored at chilled temperature followed by storage at an ambient temperature. For example, the packaged fruit is first stored at chilled temperature (at about 3° C. to about 10° C., or about 3° C. to about 7° C. or about 5° C.) for up to 1 day, 2 days, 3 days, 4 days, 5 days or 6 days followed by storage at an ambient temperature (from about 14° C. to about 20° C., or at about 14° C. to about 18° C., or at about 16° C.) for at least 1 day, 2 days, 3 days, 4 days, 5 days, 6 days, 7 days, 8 days, 9 days, 10 days, 11 days or 12 days.

Antimist

In some embodiments the packaging film is coated with an antimist composition.

Antimist compositions and coatings are well known in the art. They generally comprise a surfactant which is formulated for application onto a range of surfaces, including those of films, wind shields, camera lens and binoculars. Reducing the build up of water vapour on the film can increase the attractiveness of the packaged fruit to the consumer. As used herein, the terms “antifog” and “antimist” are interchangeable.

Apparatus

In some embodiments, the fruit packer is a flow wrapper.

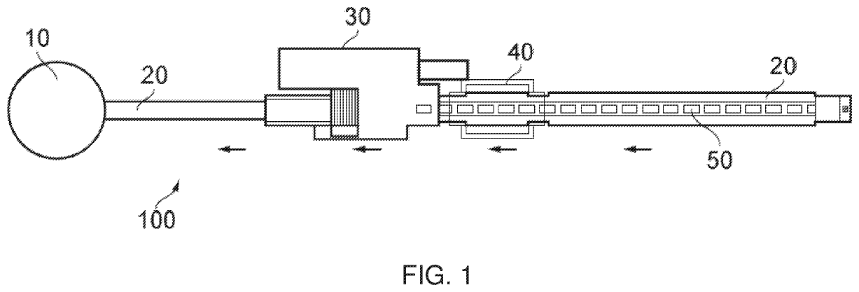

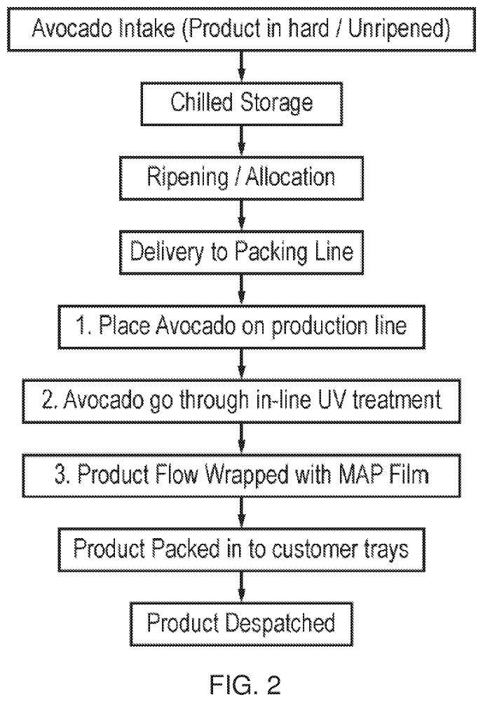

Referring now to FIG. 1, which represents an embodiment of the apparatus according to the present invention. A system (100) for fruit packaging comprises a conveyer belt (20) which traverses a UV source (40) and a fruit packer (flow wrapper) (30). The directional arrows specify the direction the conveyer belt moves, and receptacles (50) hold the fruit prior to entry into the UV source and the flow wrapper. A table (10) may store the packed fruit. FIG. 2 shows one mode of operation of the apparatus and method of the present invention (denoted by the numbered steps) shown in association with the complete process from avocado intake to product despatch to retailer.

In some embodiments, the fruit is held in the apparatus such that the stem faces the UV light source during the treatment with UV light.

In some embodiments, the surface for holding the fruit is configured so the stem of the fruit faces the UV light source during exposure to UV light.

In some embodiments, the apparatus further has a means for introducing ozone into the package of the packaged fruit.

In some embodiments, ozone is introduced before the package is sealed.

In some embodiments, ozone is introduced into the packaging using an ozone generator. The ozone generator may be fixed to the production line of the fruit packaging apparatus in order for the treatment to be applied. Optionally, an air ozone sensor is used to determine the concentration of ozone. The air ozone sensor may be fixed inside the contained ozone gas. Typically, once the sensor detects the desired ozone concentration has been achieved the ozone generator is switched off automatically.

In some embodiments, ozone is generated after the package is sealed. For example, ozone is generated in the packaging of the packaged fruit using a cold plasma system which generates the ozone within the sealed packaging (oxygen within the packaging is converted into ozone). Anacail is a provider of such a cold plasma system.

Typically, the ozone concentration level in the modified atmosphere within the packaging film is between about 0.25 to about 5 ppm. In some embodiments, the ozone concentration levels in the modified atmosphere within the packaging film is between about 0.25 to about 3 ppm, between about 0.4 to about 2.5 ppm, between about 0.5 to about 2 ppm, between about 0.5 to about 1.5 ppm, or between about 0.5 to about 1 ppm.

In some embodiments, the packaging film (e.g. MAP film) is configured to have a reduced O₂ concentration compared to the environment surrounding the packaged fruit.

In some embodiments, the packaging film (e.g. MAP film) is configured to have an increased CO₂ concentration compared to the environment surrounding the packaged fruit.

In some embodiments, the packaging film (e.g. MAP film) is configured to maintain a modified atmosphere comprising from about 6% to about 20%, from about 6% to about 18%, from about 8% to about 14%, from about 9% to about 13%, or from about 10% to about 12% O₂ after 2 days or 4 days or 6 days or 8 days or 10 days post-packaging storage at a chilled temperature.

In some embodiments, the packaging film (e.g. MAP film) is configured to maintain a modified atmosphere comprising from about 5% to about 15%, from about 5% to about 14%, from about 6% to about 14%, from about 6% to about 13%, from about 6% to about 12%, from about 7% to about 14%, from about 7% to about 13%, from about 7% to about 12%, from about 8% to about 12%, from about 8% to about 11%, or from about 8% to about 10% CO₂ after 2 days or 4 days or 6 days or 8 days or 10 days post-packaging storage at a chilled temperature.

In some embodiments, the packaging film (e.g. MAP film) is configured to maintain a modified atmosphere comprising from about 6% to about 20% O₂ and from about 6% to about 14% CO₂, from about 6% to about 18% O₂ and from about 6% to about 14% CO₂, from about 8% to about 14% O₂ and from about 5% to about 15% CO₂, from about 9% to about 13% O₂ and from about 6% to about 13% CO₂, from about 9% to about 13% O₂ and from about 7% to about 13% CO₂, from about 9% to about 13% O₂ and from about 8% to about 12% CO₂, from about 10% to about 12% O₂ and from about 8% to about 12% CO₂, from about 10% to about 12% O₂ and from about 8% to about 10% CO₂ after 2 days or 4 days or 6 days or 8 days or 10 days post-packaging storage at a chilled temperature.

In some embodiments, the packaging film (e.g. MAP film) is configured to maintain a modified atmosphere comprising from about 4% to about 16%, from about 5% to about 12%, from about 6% to about 12%, from about 6% to about 11%, from about 6% to about 10%, from about 6% to about 9%, from about 6% to about 8%, from about 6% to about 7%, from about 7% to about 10%, from about 7% to about 9%, from about 7% to about 8%, or about 7% O₂ after 2 days or 4 days or 6 days or 8 days or 10 days post-packaging storage at an ambient temperature.

In some embodiments, the packaging film (e.g. MAP film) is configured to maintain a modified atmosphere comprising from about 6% to about 18%, from about 6% to about 14%, from about 6% to about 13%, from about 7% to about 17%, from about 7% to about 14%, from about 7% to about 13%, from about 8% to about 14%, from about 8% to about 13%, from about 9% to about 16%, from about 9% to about 14%, from about 9% to about 13%, from about 10% to about 14%, from about 11% to about 14%, from about 12% to about 14%, or from about 13% to about 14% CO₂ after 2 days or 4 days or 6 days or 8 days or 10 days post-packaging storage at an ambient temperature.

In some embodiments, the packaging film (e.g. MAP film) is configured to maintain a modified atmosphere comprising from about 6% to about 10% O₂ and from about 6% to about 18% CO₂, from about 6% to about 10% O₂ and from about 9% to about 16% CO₂, from about 6% to about 12% O₂ and from about 6% to about 14% CO₂, from about 6% to about 10% O₂ and from about 9% to about 14% CO₂, from about 6% to about 8% O₂ and from about 11% to about 14% CO₂, from about 6% to about 8% O₂ and from about 11% to about 14% CO₂, from about 6% to about 8% O₂ and from about 12% to about 14% CO₂, from about 6% to about 8% O₂ and from about 13% to about 14%, or about 7% O₂ and from about 13% to about 14% CO₂ after 2 days or 4 days or 6 days or 8 days or 10 days post-packaging storage at an ambient temperature.

In some embodiments, the packaging film (e.g. MAP film) is configured to maintain a modified atmosphere after first storage at a chilled temperature for 1, 2, 3, 4, 5 or 6 days post-packaging storage followed by storage at an ambient temperature for 1, 2, 3, 4, 5, 6, 7, 8, 9, 10, 11 or 12 days post-packaging.

In some embodiments, the packaging film (e.g. MAP film) is configured to maintain a modified atmosphere comprising from about 4% to about 18%, from about 5% to about 13%, from about 6% to about 18%, from about 6% to about 14%, from about 6% to about 12%, or from about 7% to about 12% O₂ after first storage at a chilled temperature for 1, 2, 3, 4, 5 or 6 days post-packaging storage followed by storage at an ambient temperature for 1, 2, 3, 4, 5, 6, 7, 8, 9, 10, 11 or 12 days post-packaging.

In some embodiments, the packaging film (e.g. MAP film) is configured to maintain a modified atmosphere comprising from about 5% to about 18%, from about 6% to about 17%, from about 6% to about 14%, from about 7% to about 16%, from about 7% to about 14%, or from about 8% to about 14% CO₂ after first storage at a chilled temperature for 1, 2, 3, 4, 5 or 6 days post-packaging storage followed by storage at an ambient temperature for 1, 2, 3, 4, 5, 6, 7, 8, 9, 10, 11 or 12 days post-packaging.

In some embodiments, the packaging film (e.g. MAP film) is configured to maintain a modified atmosphere comprising from about 6% to about 12% O₂ and from about 7% to about 16% CO₂, from about 6% to about 12% O₂ and from about 7% to about 14% CO₂, or from about 7% to about 12% O₂ and from about 8% to about 14% CO₂ after first storage at a chilled temperature for 1, 2, 3, 4, 5 or 6 days post-packaging storage followed by storage at an ambient temperature for 1, 2, 3, 4, 5, 6, 7, 8, 9, 10, 11 or 12 days post-packaging.

In some embodiment, the MAP film is configured to maintain a modified atmosphere comprising from about 6% to about 20% O₂ and/or from about 6% to about 14% CO₂ after 10 days post-packaging storage at a chilled temperature.

In some embodiments, the MAP film is configured to maintain a modified atmosphere comprising from about 9% to about 13% O₂ and/or from about 7% to about 13% CO₂ after 10 days post-packaging storage at a chilled temperature.

In some embodiments, the MAP film is configured to maintain a modified atmosphere comprising from about 8% to about 14% O₂ and from about 5% to about 15% CO₂ after 10 days post-packaging storage at a chilled temperature.

In some embodiments, the MAP film is configured to maintain a modified atmosphere comprising from about 6% to about 12% O₂ and/or from about 6% to about 14% CO₂ after 10 days post-packaging storage at an ambient temperature.

In some embodiments, the MAP film is configured to maintain a modified atmosphere comprising from about 6% to about 10% O₂ and/or from about 9% to about 16% CO₂ after 10 days post-packaging storage at an ambient temperature.

In some embodiments, the MAP film is configured to maintain a modified atmosphere comprising from about 6% to about 10% O₂ and from about 6% to about 18% CO₂ after 10 days post-packaging storage at an ambient temperature.

In some embodiments, the packaging film (e.g. MAP film) is configured to maintain a modified atmosphere comprising from about 8% to about 14% O₂ and/or from about 5% to about 15% CO₂ after 2 days or 4 days or 6 days or 8 days or 10 days post-packaging storage at a chilled temperature or wherein the modified atmosphere within the packaging film is configured to maintain a modified atmosphere comprising from about 6% to about 10% O₂ and/or from about 6% to about 18% CO₂ after 2 days or 4 days or 6 days or 8 days or 10 days post-packaging storage at an ambient temperature.

In some embodiments, the configuration of the packaging film (e.g. MAP film) increases the shelf life of a packaged fruit by at least 1 day or 2 days when the packaged fruit is stored at a chilled temperature. In addition, or alternatively, the configuration of the packaging film (e.g. MAP film) increases the shelf life of a packaged fruit by at least 1 day or 2 days when it is stored at an ambient temperature. In addition, or alternatively, the configuration of the packaging film (e.g. MAP film) increases the shelf life of a packaged fruit by at least 1 day or 2 days when the packaged fruit is first stored at a chilled temperature followed by storage at an ambient temperature.

The invention will now be further described by way of Examples, which are meant to serve to assist one of ordinary skill in the art in carrying out the invention and are not intended in any way to limit the scope of the invention.

### EXAMPLES

### Example 1—Reduced MAP Film Permeability on Ripen at Home Avocados

The present inventors found that the MAP film permeability with an OTR of 38,000 cc/m²/day was not optimal for storing the ripen at home avocados (which had been treated with UV before packaging) when the avocados have a high dry-matter content.

Samples of the Ripen at home (RAH) avocados were packed and delivered to the Food Science lab for shelf life testing, with the aim of evaluating the benefit of the MAP film, with an OTR of 14,300 cc/m²/day, on the overall quality of RAH avocados stored at ambient temperature or at chilled temperature.

The dry-matter content of the avocados was above 32% and typically was 36-40%.

### Methods

Ripen at home Hass avocado packed in (i) the needle perforated film or (ii) MAP film with an OTR of 14,300 cc/m²/day were delivered to the Laboratory on the 12 Oct. 2018.

Both the avocados packaged in MAP film and the avocados packaged in needle perforated film had been treated with UV. 254 nm wavelength UV light has been used, with the fruit being exposed at a distance of around 50 mm away from the UV source for approximately 3 seconds. Unlike the fruit packaged in MAP film, the levels of O₂ and CO₂ within the headspace of fruit packaged in needle perforated film will not be modified over time.

Half of the samples were stored at ambient temperature (16±2° C.) and the other half were stored at chill temperature (5±2° C.) for 12 days after packaging. Headspace oxygen and carbon dioxide were measured daily in the packs using an Emco Technologies Stratos gas analyser. Gas-tight self-sealing silicon septa (Toray Engineering) were used to allow repeat measurements to be obtained from the same pack.

Packs were opened throughout shelf life, and firmness analysis, along with sensory observation (Taste, aroma, texture/mouthfeel, and internal/external visual impressions), was carried out.

Moisture loss was determined by weighing the fruit.

### Results—Ripen at Home Avocados Stored at Chilled Temperature

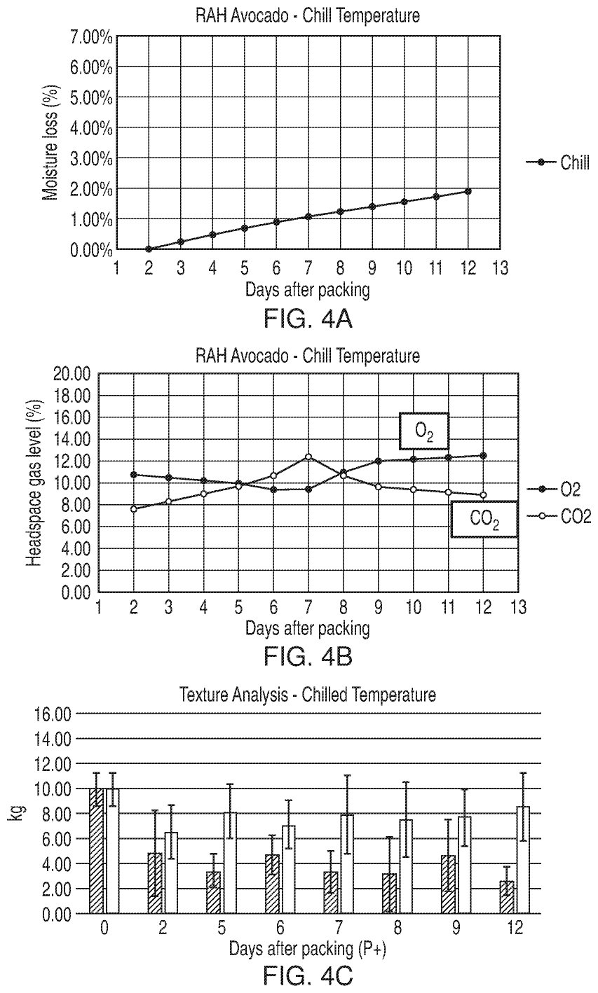

FIG. 4A shows the mean percentage moisture loss during the trial from RAH avocados stored at a chilled temperature and packaged in film with an OTR of 14300 cc/m²/day.

FIG. 4B shows the mean levels of O₂ and CO₂ in the headspace throughout the trial of RAH avocados stored at a chilled temperature and packaged in film with an OTR of 14300 cc/m²/day. The in-pack oxygen and carbon dioxide levels vary between 10-12% and 8-10%, respectively, throughout the shelf life trial.

FIG. 4C shows the mean firmness of RAH avocados stored at chilled temperature and packaged in MAP film with an OTR of 14300 cc/m²/day or packaged in needle-perforated film (control). FIG. 4C shows that the firmness was retained in the ripen-at-home avocados packed in the MAP film (with an OTR of 14,300 cc/m²/day). FIG. 4C shows that the fruit in the needle perforated film became much softer as time increased. The high standard deviation bar reflects the internal variability in firmness between samples.

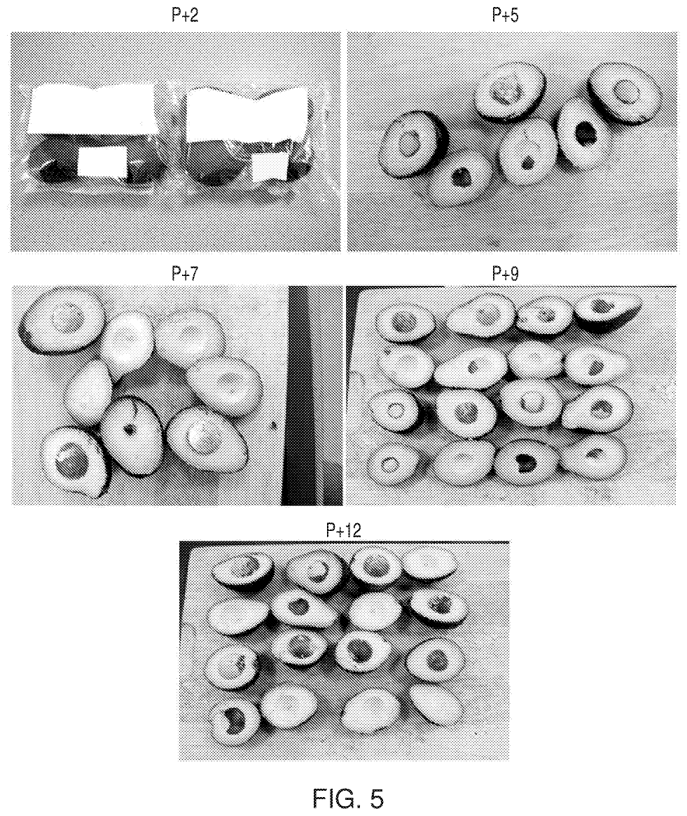

The avocado samples stored at chill temperature in needle-perforated film looked good throughout shelf life testing. However, discolouration and off-colour was observed. See FIG. 5.

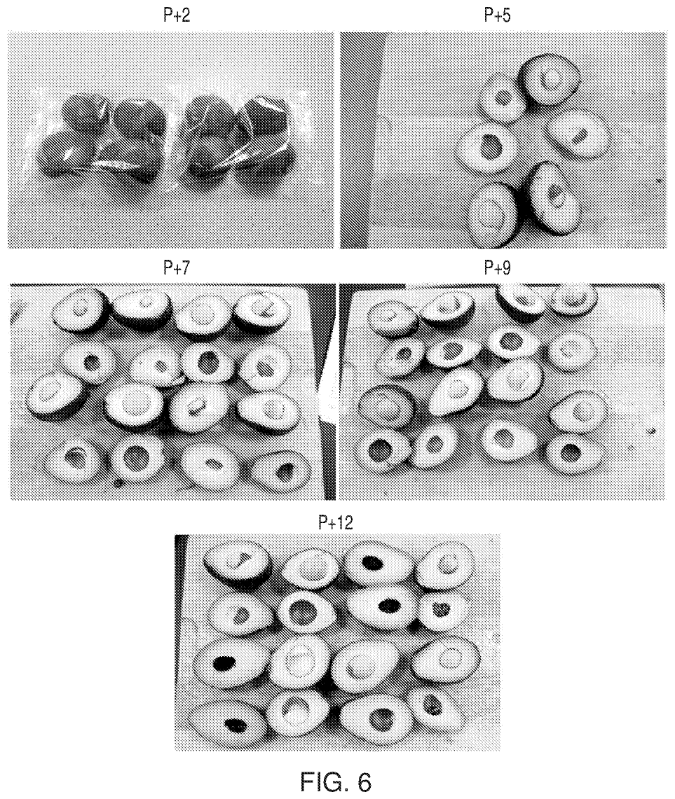

The Ripen at home avocados stored at chilled temperature in MAP film with an OTR of 14,300 cc/m²/day looked good throughout shelf life testing, with no discolouration and no off-odour development being observed. See FIG. 6.

### Results—Ripen at Home Avocados Stored at Ambient Temperature

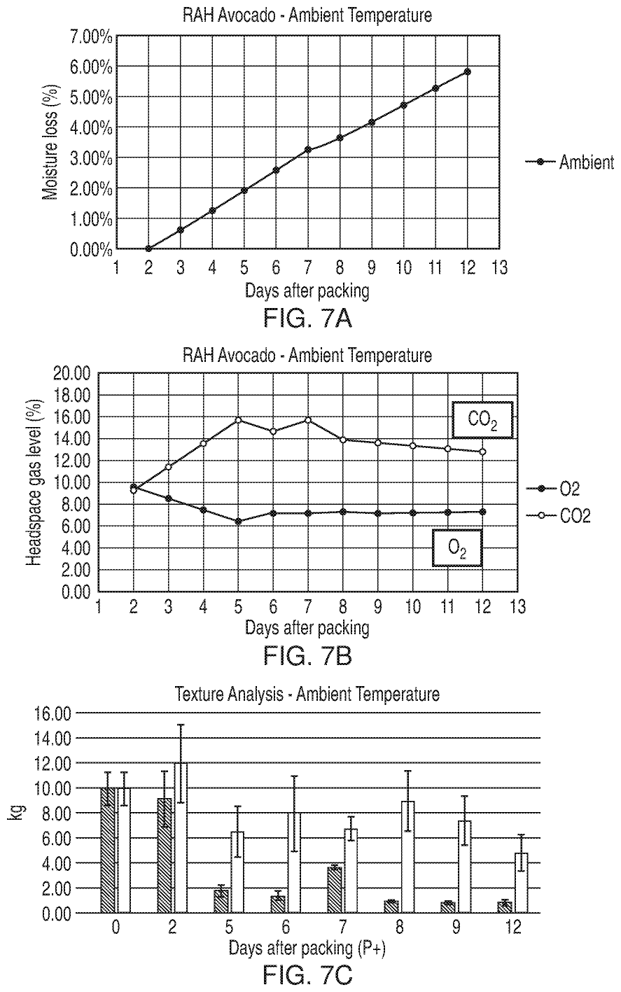

FIG. 7A shows the mean percentage moisture loss during the trial from RAH avocados stored at an ambient temperature and packaged in film with an OTR of 14300 cc/m²/day.

FIG. 7B shows the mean levels of O₂ and CO₂ in the headspace throughout the trial of RAH avocados stored at an ambient temperature and packaged in film with an OTR of 14300 cc/m²/day. The oxygen and carbon dioxide levels of the samples stored at ambient temperature were modified, with about 7% O₂ and about 13-14% CO₂ recorded towards the end of testing.

FIG. 7C shows the mean firmness of RAH avocados stored at chilled temperature and packaged in MAP film with an OTR of 14300 cc/m²/day or packaged in needle-perforated film (control). This figure shows the benefit of the MAP film with an OTR of 14,300 cc/m²/day on the firmness' retention of the ripen at home avocados stored at ambient temperature. FIG. 7C shows that the fruit in the needle perforated film became much softer as time increased.

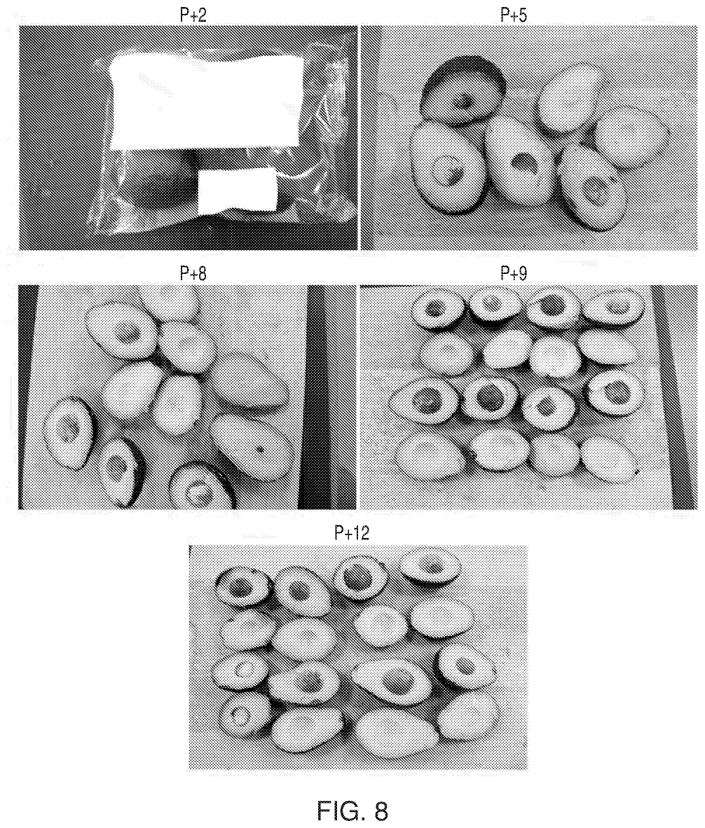

The ripen at home avocados packed in the needle perforated (punch perforated) film looked good throughout shelf life testing; however, vascular browning discolouration was visualised on three/four avocados from P+8 onwards. The fruits were found to be very soft from P+5 onwards. See FIG. 8.

Apart from one avocado, which has been affected by an internal discolouration half way through shelf life testing, the fruits packed in the MAP film with an OTR of 14,300 cc/m²/day and stored at ambient temperature looked good until the end of life. No off-odour development was observed throughout the duration of the trial.

Table C shows the percentage reduction in firmness of (i) avocados treated with UV and packaged in a MAP film with an OTR of 14,300 cc/m²/day and stored at a chilled temperature; (ii) control avocados packaged in a needle-perforated film and stored at a chilled temperature; (iii) avocados treated with UV and packaged in a MAP film with an OTR of 14,300 cc/m²/day and stored at an ambient temperature; and (iv) control avocados packaged in a needle-perforated film and stored at an ambient temperature. As can be seen from Table C, avocados treated with UV and packaged in a MAP film with an OTR of 14,300 cc/m²/day had a much lower reduction in firmness (i.e. there was less softening of the fruit) than the avocados in needle-perforated film at both a chilled temperature and ambient temperature. In addition, avocados treated with UV and packaged in a MAP film with an OTR of 14,300 cc/m²/day had a prolonged life and a slower senescence. Table D shows the average loss in firmness over a shelf-life of 12 days after packaging.

TABLE C

| | UV/Map X - | | | | UV/Map X - | | Control | |
|---|---|---|---|---|---|---|---|---|
| | Chill | Average % | Control Chill | Average % of | Ambient | Average % of | Ambient | Average % of |
| | Average Fruit | of reduction | Average Fruit | reduction in | Average Fruit | reduction in | Average Fruit | reduction in |
| Shelf life | Firmness (lbs) | in firmness | Firmness (lbs) | firmness | Firmness (lbs) | firmness | Firmness (lbs) | firmness |
| 0 - Prior | 9.96 | | 9.96 | | 9.96 | | 9.96 | |
| Packing | | | | | | | | |
| 2 | 6.54 | 34.33% | 4.86 | 51.20% | 11.97 | −20.18% | 9.14 | 8.23% |
| 5 | 8.16 | 18.17% | 3.35 | 66.36% | 6.44 | 35.34% | 1.71 | 82.83% |
| 6 | 7.09 | 28.81% | 4.71 | 52.71% | 7.91 | 21.35% | 1.30 | 89.64% |
| 7 | 7.94 | 20.28% | 3.35 | 66.36% | 6.69 | 32.83% | 3.57 | 64.15% |
| 8 | 7.52 | 24.49% | 3.17 | 68.17% | 8.87 | 10.94% | 0.86 | 94.79% |
| 9 | 7.71 | 22.59% | 4.67 | 53.11% | 7.30 | 26.70% | 0.72 | 92.03% |
| 12 | 8.59 | 13.75% | 2.60 | 73.90% | 4.75 | 52.30% | 0.76 | 95.83% |

TABLE D
Average loss in firmness during shelf life from day 0-12

| | | | | | | | |
|---|---|---|---|---|---|---|---|
| UV/Map X - Chill | 23.20% | Control Chill | 61.68% | UV/Map X - Ambient | 29.91% | Control Ambient | 75.35% |

### Conclusion

The performance of the MAP film with an OTR of 14,300 cc/m²/day against the current needle perforated packaging was evaluated in this shelf life trial.

The oxygen and carbon dioxide levels of the samples stored at chilled temperature nearly reached optimal levels, with 10-12% O₂ and 8-10% CO₂ recorded throughout shelf life testing. At ambient temperature, the equilibrium oxygen and carbon dioxide levels were found to be strongly modified, with 7% and 13-14%, respectively. Results from the Fruit Texture Analyser (FTA) indicated the firmness retention of the ripen at home avocados packed in the MAP film, as opposed to the needle perforated film, was better regardless the storage temperature. The benefit of the MAP film with an OTR of 14,300 cc/m²/day on the firmness retention was remarkably demonstrated at ambient storage condition. The high standard deviation bar reflected the internal variability in firmness between samples. The sensory quality of the avocados packed in the MAP film with an OTR of 14,300 cc/m²/day remained generally good throughout the shelf life trial. The discolouration being observed half way through testing might have resulted from the internal avocado variability.

### Example 2—Dry-Matter Content of Hass Avocados

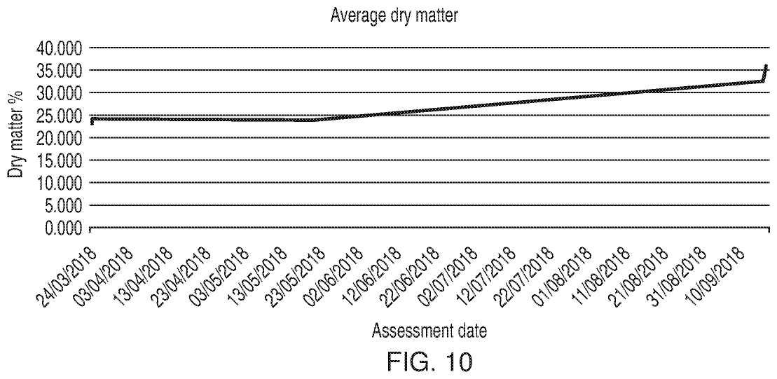

The dry-matter content of pallets of Hass avocados was determined. The avocados were grown in South Africa. The average percentage dry-matter content throughout the season of Hass avocados grown in South Africa is shown in Table E and FIG. 10. 10 fruit were randomly selected and the dry-matter was determined by: cutting the fruit into chunks and removing the skin; weighing the mesocarp portion of the fruit to obtain the wet weight; placing the mesocarp fruit sample into an oven and baking it for 4 hours at 105° C. so that the mesocarp was dry and weighing the sample to obtain the dry weight; the percentage dry-matter was calculated as detailed above.

TABLE E
the dry-matter content of Hass avocados grown in South Africa.

| Date | Average dry-matter |
|---|---|
| 24 Mar. 2018 | 23.407 |
| 24 Mar. 2018 | 24.350 |
| 20 May 2018 | 23.947 |
| 15 Sep. 2018 | 32.642 |
| 16 Sep. 2018 | 36.050 |

As can be seen from Table E, the late season avocados have a high dry-matter content. Typically the level of dry-matter is much lower in avocado earlier on in the season.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in molecular biology or related fields are intended to be within the scope of the following claims.

Summary Paragraphs

The present invention is defined in the claims and the accompanying description. For convenience other aspects of the present invention are presented herein by way of numbered paragraphs (para.s).

1. A method for increasing the shelf life of fruit comprising the steps of:

i) treating a fruit with UV light from a UV light source,

ii) packaging the fruit in packaging film that allows the fruit to be stored in a modified atmosphere within the packaging film, and

iii) storing the packaged fruit,

wherein the fruit has a high dry-matter content;

wherein the packaging film is a modified atmosphere packaging (MAP) film, wherein the MAP film has an oxygen transmission rate (OTR) of about 8000 cc/m²/day to about 45000 cc/m²/day; and

wherein the method is capable of increasing the shelf life of the packaged fruit by at least 1 day or 2 days when the packaged fruit is stored at a chilled temperature;

and/or

wherein the method is capable of increasing the shelf life of the packaged fruit by at least 1 day or 2 days when the packaged fruit is stored at an ambient temperature;

and/or

wherein the method is capable of increasing the shelf life of the packaged fruit by at least 1 day or 2 days when the packaged fruit is first stored at a chilled temperature followed by storage at an ambient temperature.

2. The method according to paragraph 1 wherein the fruit has a dry-matter content of at least 26%, 28%, 30%, 32% or 34%.

3. The method according to paragraph 1 or 2, wherein the modified atmosphere within the packaging film has a reduced O₂ concentration compared to the environment surrounding the packaged fruit.

4. The method according to any one of paragraphs 1 to 3, wherein the modified atmosphere within the packaging film has an increased CO₂ concentration compared to the environment surrounding the packaged fruit.

5. The method according to any one of paragraphs 1 to 4, wherein the modified atmosphere within the packaging film comprises ozone.

6. The method according to paragraph 5, comprising a further step of introducing ozone into the modified atmosphere within the packaging film.

7. The method according to any one of paragraphs 1 to 6 wherein the MAP film has an oxygen transmission rate (OTR) of about 8000 cc/m²/day to about 19500 cc/m²/day.

8. The method according to any one of paragraphs 1 to 6 wherein the MAP film has an oxygen transmission rate (OTR) of about 14000 cc/m²/day to about 15000 cc/m²/day.

9. The method according to any one of paragraphs 1 to 6 wherein the MAP film has an oxygen transmission rate (OTR) of about 14300 cc/m²/day.

10. The method according to any one of paragraphs 1 to 9 wherein the modified atmosphere within the packaging film comprises from about 9% to about 13% O₂ and/or from about 7% to about 13% CO₂ after 10 days post-packaging storage at a chilled temperature.

11. The method according to any one of paragraphs 1 to 9 wherein the modified atmosphere within the packaging film comprises from about 6% to about 10% O₂ and/or from about 9% to about 16% CO₂ after 10 days post-packaging storage at an ambient temperature.

12. The method according to any one of paragraphs 1 to 11 wherein softening of the fruit is reduced.

13. The method according to paragraph 12 wherein the fruit has a reduction in firmness of no more than about 40% after storage at a chilled temperature for 2, 3, 4, 5, 6, 7, 8, 9 or 12 days post-packaging; and/or wherein the fruit has a reduction in firmness of no more than about 55% after storage at an ambient temperature for 2, 3, 4, 5, 6, 7, 8, 9 or 12 days post-packaging; and/or wherein the fruit has a reduction in firmness of no more than about 55% after first storage at a chilled temperature for up to 1 day, 2 days, 3 days, 4 days, 5 days or 6 days post-packaging followed by storage at an ambient temperature for 2, 3, 4, 5, 6, 7, 8, 9 or 12 days post-packaging.

14. The method according to any one of paragraphs 1 to 13, wherein the incidence of rot in the packaged fruit is reduced.

15. The method according to paragraph 14 wherein the rot is stem end rot and/or anthracnose.

16. The method according to paragraph 14 or 15, further comprising a step of positioning the fruit in a holder such that the stem faces the UV light source during the treatment with UV light.

17. The method according to any one of paragraphs 1 to 16 wherein the fruit is treated with UV light before and/or during and/or after packaging the fruit.

18. The method according to any one of paragraphs 1 to 17 wherein the UV light is UV-C light.

19. The method according to any one of paragraphs 1 to 18 wherein the UV light has a wavelength of between about 100 nm and about 280 nm, or between about 200 nm and about 270 nm, or between about 240 nm and about 270 nm, or between about 250 nm and about 260 nm, or about 254 nm.

20. The method according to any one of paragraphs 1 to 19 wherein the fruit is treated with a dose of UV light in the range of about 20 mJ/cm² to about 40 mJ/cm², or about 25 mJ/cm² to about 35 mJ/cm², or about 30 mJ/cm².

21. The method according to any one of paragraphs 1 to 20 wherein the fruit is exposed to the UV light for about 1 to about 10 seconds, or about 1 to about 5 seconds, or for about 3 seconds.

22. The method according to any one of paragraphs 1 to 21 wherein the distance between the source of UV light and the fruit is about 10 mm to about 100 mm, or about 30 mm to about 70 mm, or about 50 mm.

23. The method according to any one of paragraphs 1 to 22 wherein the packaged fruit is stored at a chilled temperature.

24. The method according to paragraph 23 wherein the packaged fruit is stored at about 3° C. to about 10° C., or about 3° C. to about 7° C., or about 5° C.

25. The method according to any one of paragraphs 1 to 22 wherein the packaged fruit is stored at an ambient temperature.

26. The method according to paragraph 25 wherein the packaged fruit is stored at an ambient temperature is from about 14° C. to about 20° C., or from about 14° C. to about 18° C., or about 16° C.

27. The method according to any one of paragraphs 1 to 26 wherein the packaging film is coated with an antimist composition.

28. The method according to any one of paragraphs 1 to 27 wherein the fruit is a ripen-at-home fruit.

29. The method according to any one of paragraphs 1 to 28 wherein the fruit is avocado.

30. The method according to paragraph 29 wherein the avocado is an avocado cultivar selected from the group consisting of Hass, Natures Hass, Muluma Hass, Lamb Hass, Gem®, Carmen, Fuerte, Pinkerton, Ryan, Reed, Linda, Carla, Ettinger, Lula, Semil, Bacon, Gwen, Zutano, and combinations thereof.

31. A packaged fruit prepared by the method according to any one of the preceding paragraphs.

32. A fruit packaging apparatus having

a) a UV light source;

b) a fruit packer capable of packaging a fruit in a packaging film that allows the fruit to be stored in a modified atmosphere within the packaging film;

c) a surface for holding the fruit wherein the surface is movable between the UV light source and the fruit packer so that the fruit can be exposed to the UV light source and fruit packer sequentially;

wherein the packaging film is a MAP film, wherein the MAP film has an oxygen transmission rate (OTR) of about 8000 cc/m²/day to about 45000 cc/m²/day; and

wherein the packaged fruit has an increase in shelf life of at least 1 day or 2 days when the packaged fruit is stored at a chilled temperature;

and/or

wherein the packaged fruit has an increase in shelf life of at least 1 day or 2 days when it is stored at an ambient temperature;

and/or

wherein the method is capable of increasing the shelf life of the packaged fruit by at least 1 day or 2 days when the packaged fruit is first stored at a chilled temperature followed by storage at an ambient temperature.

33. The apparatus according to paragraph 32, wherein the fruit is held in the apparatus such that the stem faces the UV light source during the treatment with UV light.

34. The apparatus according to paragraph 32 or 33 wherein the MAP film has an oxygen transmission rate (OTR) of about 8000 cc/m²/day to about 19500 cc/m²/day.

35. The apparatus according to paragraph 32 or 33 wherein the MAP film has an oxygen transmission rate (OTR) of about 14000 cc/m²/day to about 15000 cc/m²/day.

36. The apparatus according to paragraph 32 or 33 wherein the MAP film has an oxygen transmission rate (OTR) of about 13400 cc/m²/day.

37. The apparatus according to any one of paragraphs 32 to 36 wherein the modified atmosphere within the packaging film comprises from about 9% to about 13% O₂ and/or from about 7% to about 13% CO₂ after 10 days post-packaging storage at a chilled temperature.

38. The apparatus according to any one of paragraphs 32 to 36 wherein the modified atmosphere within the packaging film comprises from about 6% to about 10% O₂ and/or from about 9% to about 16% CO₂ after 10 days post-packaging storage at an ambient temperature.

1. A method for increasing the shelf life of fruit comprising the steps of:
i) treating a fruit with UV light from a UV light source,
ii) packaging the fruit in packaging film that allows the fruit to be stored in a modified atmosphere within the packaging film, and
iii) storing the packaged fruit,
wherein the fruit has a high dry-matter content;
wherein the packaging film is a modified atmosphere packaging (MAP) film, wherein the MAP film has an oxygen transmission rate (OTR) of about 8000 cc/m²/day to about 17500 cc/m²/day; and
wherein the method is capable of increasing the shelf life of the packaged fruit by at least 1 day or 2 days when the packaged fruit is stored at a chilled temperature;
and/or
wherein the method is capable of increasing the shelf life of the packaged fruit by at least 1 day or 2 days when the packaged fruit is stored at an ambient temperature;
and/or
wherein the method is capable of increasing the shelf life of the packaged fruit by at least 1 day or 2 days when the packaged fruit is first stored at a chilled temperature followed by storage at an ambient temperature.

2. The method according to claim 1 wherein the fruit has a dry-matter content of at least 26%, 28%, 30%, 32% or 34%.

3. The method according to claim 1 or 2, wherein the modified atmosphere within the packaging film has a reduced O₂ concentration compared to the environment surrounding the packaged fruit.

4. The method according to any one of claims 1 to 3, wherein the modified atmosphere within the packaging film has an increased CO₂ concentration compared to the environment surrounding the packaged fruit.

5. The method according to any one of claims 1 to 4, wherein the modified atmosphere within the packaging film comprises ozone.

6. The method according to claim 5, comprising a further step of introducing ozone into the modified atmosphere within the packaging film.

7. The method according to any one of claims 1 to 6 wherein the MAP film has an oxygen transmission rate (OTR) of about 13000 cc/m²/day to about 16000 cc/m²/day.

8. The method according to any one of claims 1 to 6 wherein the MAP film has an oxygen transmission rate (OTR) of about 14000 cc/m²/day to about 15000 cc/m²/day.

9. The method according to any one of claims 1 to 6 wherein the MAP film has an oxygen transmission rate (OTR) of about 14300 cc/m²/day.

10. The method according to any one of claims 1 to 9 wherein the modified atmosphere within the packaging film comprises from about 9% to about 13% O₂ and/or from about 7% to about 13% CO₂ after 10 days post-packaging storage at a chilled temperature.

11. The method according to any one of claims 1 to 9 wherein the modified atmosphere within the packaging film comprises from about 6% to about 10% O₂ and/or from about 9% to about 16% CO₂ after 10 days post-packaging storage at an ambient temperature.

12. The method according to any one of claims 1 to 11 wherein softening of the fruit is reduced.

13. The method according to claim 12 wherein the fruit has a reduction in firmness of no more than about 40% after storage at a chilled temperature for 2, 3, 4, 5, 6, 7, 8, 9, 10 or 12 days post-packaging; and/or wherein the fruit has a reduction in firmness of no more than about 55% after storage at an ambient temperature for 2, 3, 4, 5, 6, 7, 8, 9, 10 or 12 days post-packaging; and/or wherein the fruit has a reduction in firmness of no more than about 55% after first storage at a chilled temperature for up to 1 day, 2 days, 3 days, 4 days, 5 days or 6 days post-packaging followed by storage at an ambient temperature for 2, 3, 4, 5, 6, 7, 8, 9, 10 or 12 days post-packaging.

14. The method according to any one of claims 1 to 13, wherein the incidence of rot in the packaged fruit is reduced.

15. The method according to claim 14 wherein the rot is stem end rot and/or anthracnose.

16. The method according to claim 14 or 15, further comprising a step of positioning the fruit in a holder such that the stem faces the UV light source during the treatment with UV light.

17. The method according to any one of claims 1 to 16 wherein the fruit is treated with UV light before and/or during and/or after packaging the fruit.

18. The method according to any one of claims 1 to 17 wherein the UV light is UV-C light.

19. The method according to any one of claims 1 to 18 wherein the UV light has a wavelength of between about 100 nm and about 280 nm, or between about 200 nm and about 270 nm, or between about 240 nm and about 270 nm, or between about 250 nm and about 260 nm, or about 254 nm.

20. The method according to any one of claims 1 to 19 wherein the fruit is treated with a dose of UV light in the range of about 20 mJ/cm² to about 40 mJ/cm², or about 25 mJ/cm² to about 35 mJ/cm², or about 30 mJ/cm².

21. The method according to any one of claims 1 to 20 wherein the fruit is exposed to the UV light for about 1 to about 10 seconds, or about 1 to about 5 seconds, or for about 3 seconds.

22. The method according to any one of claims 1 to 21 wherein the distance between the source of UV light and the fruit is about 10 mm to about 100 mm, or about 30 mm to about 70 mm, or about 50 mm.

23. The method according to any one of claims 1 to 22 wherein the packaged fruit is stored at a chilled temperature.

24. The method according to claim 23 wherein the packaged fruit is stored at about 3° C. to about 10° C., or about 3° C. to about 7° C., or about 5° C.

25. The method according to any one of claims 1 to 22 wherein the packaged fruit is stored at an ambient temperature.

26. The method according to claim 25 wherein the packaged fruit is stored at an ambient temperature from about 14° C. to about 20° C., or from about 14° C. to about 18° C., or about 16° C.

27. The method according to any one of claims 1 to 26 wherein the packaging film is coated with an antimist composition.

28. The method according to any one of claims 1 to 27 wherein the fruit is a ripen-at-home fruit.

29. The method according to any one of claims 1 to 28 wherein the fruit is avocado.

30. The method according to claim 29 wherein the avocado is an avocado cultivar selected from the group consisting of Hass, Natures Hass, Muluma Hass, Lamb Hass, Gem®, Carmen, Fuerte, Pinkerton, Ryan, Reed, Linda, Carla, Ettinger, Lula, Semil, Bacon, Gwen, Zutano, and combinations thereof.

31. A packaged fruit prepared by the method according to any one of the preceding claims.

32. A fruit packaging apparatus having
a) a UV light source;
b) a fruit packer comprising a packaging film wherein said fruit packer is configured to package a fruit in the packaging film that allows the fruit to be stored in a modified atmosphere within the packaging film;
c) a surface for holding the fruit wherein the surface is movable between the UV light source and the fruit packer so that the fruit can be exposed to the UV light source and fruit packer sequentially;
wherein the packaging film is a MAP film, wherein the MAP film has an oxygen transmission rate (OTR) of about 8000 cc/m²/day to about 17500 cc/m²/day.

33. The apparatus according to claim 32, wherein the fruit is held in the apparatus such that the stem faces the UV light source during the treatment with UV light.

34. The apparatus according to claim 32 or 33 wherein the MAP film has an oxygen transmission rate (OTR) of about 13000 cc/m²/day to about 16000 cc/m²/day.

35. The apparatus according to claim 32 or 33 wherein the MAP film has an oxygen transmission rate (OTR) of about 14000 cc/m²/day to about 15000 cc/m²/day.

36. The apparatus according to claim 32 or 33 wherein the MAP film has an oxygen transmission rate (OTR) of about 13400 cc/m²/day.

37. The apparatus according to any one of claims 32 to 36 wherein the MAP film is configured to maintain a modified atmosphere comprising from about 6% to about 20% O₂ and/or from about 6% to about 14% CO₂ after 10 days post-packaging storage at a chilled temperature.

38. The apparatus according to any one of claims 32 to 36 wherein the MAP film is configured to maintain a modified atmosphere comprising from about 9% to about 13% O₂ and/or from about 7% to about 13% CO₂ after 10 days post-packaging storage at a chilled temperature.

39. The apparatus according to any one of claims 32 to 36 wherein the MAP film is configured to maintain a modified atmosphere comprising from about 8% to about 14% O₂ and from about 5% to about 15% CO₂ after 10 days post-packaging storage at a chilled temperature.

40. The apparatus according to any one of claims 32 to 36 wherein the MAP film is configured to maintain a modified atmosphere comprising from about 6% to about 12% O₂ and/or from about 6% to about 14% CO₂ after 10 days post-packaging storage at an ambient temperature.

41. The apparatus according to any one of claims 32 to 36 wherein the MAP film is configured to maintain a modified atmosphere comprising from about 6% to about 10% O₂ and/or from about 9% to about 16% CO₂ after 10 days post-packaging storage at an ambient temperature.

42. The apparatus according to any one of claims 32 to 36 wherein the MAP film is configured to maintain a modified atmosphere comprising from about 6% to about 10% O₂ and from about 6% to about 18% CO₂ after 10 days post-packaging storage at an ambient temperature.
